(19) United States
(12) Patent Application Publication
(10) Pub. No.: US 2001/0053165 A1
(43) Pub. Date: Dec. 20, 2001

(54) Apparatuses and methods for generating optical signals

(76) Inventors: Xiaolu Wang, Wilmington, DE (US); Guifang Li, Oviedo, FL (US); Patrick LiKamWa, Orlando, FL (US); Paul K. Yu, San Diego, CA (US)

Correspondence Address: Toby H. Kusmer, McDermott, Will & Emery, 28 State Street, Boston, MA, 02109-1775, US

(21) Appl. No.: 09/803,504

(22) Filed: Mar. 9, 2001

Related U.S. Application Data
(60) Provisional application No. 60/188,073, filed on Mar. 9, 2000.

(51) Int. Cl. H01S 3/00

(52) U.S. Cl. 372/38.02

(57) ABSTRACT

Disclosed apparatuses include a return-to-zero (RZ) optical pulse generator, a non-return-to zero (NRZ) modulator, and a return-to-zero (RZ) transmitter. The apparatuses incorporate an electro-absorption modulator (EAM) and a controller that controls DC and AC voltages supplied to the EAM to provide the capability to vary its duty cycle. The apparatuses can also incorporate a phase modulator (PM) supplied with DC and AC voltages governed by the controller, to introduce frequency chirp into optical signals generated by the apparatuses. Elements such as the EAM and PM can be formed as an integrated unit on a substrate.

### CROSS-REFERENCE TO RELATED APPLICATION

This nonprovisional patent application claims priority benefits under Title 35, United States Code §119(e) based upon the provisional application entitled Method of Efficiently Generating Variable Duty-Cycle Return-to-Zero Pulses assigned U.S. Provisional Application No. 60/188,073 filed Mar. 9, 2000 naming Xiaolu Wang as inventor.

### FIELD OF THE INVENTION

1. Background of the Invention

The disclosed apparatuses incorporate an electro-absorption modulator (EAM) and controller for generating optical signals. These versatile elements can be used in the generation of a return-to-zero (RZ) optical pulse signal with variable duty-cycle and variable chirp, a non-return-to-zero (NRZ) optical data signal with variable chirp compensation, or a return-to-zero (RZ) optical data signal with variable duty-cycle and variable chirp, for example. The disclosure is further directed to an integrated unit containing the EAM and other elements, as well as to related methods.

2. Description of the Related Art

Research and development efforts around the world in recent years have led to the adoption of the return-to-zero (RZ) format as the dominant modulation format for long-reach (one-hundred (100) kilometers or more) optical communications systems, particularly at high bit rates above ten (10) gigabits per second (Gbps). One reason for this is that RZ-formatted optical pulses are closer to ideal soliton pulses because the optical pulse shape is better preserved over long distances as compared to conventional NRZ-formatted signals. Also, optical receivers generally have several decibels (dB) of sensitivity to RZ-formatted signals as compared to other signal formats. Furthermore, RZ format is less adversely affected by nonlinearities of optical fiber transmission paths despite the fact that self-phase modulation is enhanced in RZ due to its relatively high pulse peak power. In addition, at relatively high input power levels, RZ signals have the advantage of soliton-like pulse compression that achieves better performance than NRZ signals for propagation in standard single-mode fiber (SMF) and non-zero dispersion-shifted fiber (NZ-DSF). This is not only true for single-wavelength-channel systems, but also multi-channel wavelength-division-multiplexed (WDM) systems. Although important in single-wavelength-channel systems, nonlinearities have more severe ramifications in multi-channel WDM systems. RZ modulation, with its higher peak powers and large bandwidth, may not be practical in high-performance WDM systems. However, further analysis reveals that RZ-formatted signals are more immune to adverse effects than NRZ-formatted signals. For NRZ transmission, the probability that one channel is in an “on” state is 1/2. On the other hand, the probability that such channel is in an “on” state in RZ transmission is less than 1/2. Therefore, due to its longer pulse width and longer interaction time between wavelengths, NRZ-formatted signals are more adversely affected by nonlinearities than RZ-formatted signals.

A RZ transmitter is composed of a RZ pulse generator and an NRZ modulator. To further take advantage of the soliton-like characteristics of the RZ format, the RZ pulses can be prechirped using phase modulation. Current chirped RZ pulse generators are available using lithium niobate (LiNbO₃) elements. Although LiNbO₃ chirped RZ pulse generators have been functional in long-reach transmission systems, they suffer from two distinctive disadvantages. First, the power consumption and footprint of LiNbO₃ chirped pulse generators are too large for large channel-count WDM systems. Second, the LiNbO₃ chirped pulse generators inherently cannot produce RZ pulses with adjustable duty cycle without suffering penalties in extinction ratio. Conventional semiconductor [e.g., gallium arsenide (GaAs) or indium phosphide (InP)] modulators may have smaller power consumption and reduced size, but suffer from relatively high insertion loss. It would be desirable to provide chirped RZ pulse generators that eliminate such disadvantages.

Unlike the RZ transmission format, NRZ suffers from nonlinear signal distortion. Hence, NRZ-formatted signals require under-compensation of linear chromatic dispersion which is dependent upon signal power and the length of the transmission path. It would be desirable to provide an apparatus and method that can readily achieve dispersion compensation for an NRZ-formatted signal.

### SUMMARY OF THE INVENTION

The disclosed invention in its various embodiments overcomes the above-noted disadvantages of previous technologies, and achieves additional advantages and objectives as noted herein.

A disclosed return-to-zero (RZ) pulse generator comprises an electro-absorption modulator (EAM) and a controller. The controller generates one or more control signals to control amplitudes of DC and AC voltages supplied to the EAM. The RZ pulse generator can comprise a clock source to generate a clock signal from which the AC voltage is derived. The EAM receives continuous wave (CW) laser light that is modulated based on the DC and AC voltages to generate an optical pulse signal with a frequency determined by the frequency of the AC voltage. The controller can be programmed to generate the DC and AC voltages to obtain a target duty cycle for the optical pulse signal generated by the EAM. The RZ pulse generator can comprise a phase modulator (PM) controlled by the controller to induce a variable frequency chirp on the optical pulse signal to counteract the effects of dispersion and the residual chirp of the EAM. The RZ pulse generator can also comprise an optical amplifier (OA) for amplifying the optical pulse signal.

A disclosed non-return-to-zero (NRZ) modulator is similar in many respects to the RZ pulse generator. However, unlike the RZ pulse generator, the NRZ modulator has an NRZ data generator that generates an NRZ data signal that is supplied to the EAM for modulation of the CW laser light. The NRZ modulator can comprise a PM to produce a frequency chirp in the NRZ optical data signal produced by the NRZ modulator to counteract the effects of dispersion and the residual chirp of the EAM.

A disclosed return-to-zero (RZ) transmitter is similar in many respects to the RZ pulse generator, and further comprises a non-return-to-zero (NRZ) modulator coupled to receive the optical pulse signal produced by the RZ pulse generator. The NRZ modulator is coupled to receive data that it modulates onto the RZ optical pulse train.

An integrated unit comprising the EAM and optionally other elements such as the PM, OA, spot-size converter(s), or impedance matching networks, is also disclosed. The disclosure further encompasses related methods.

These together with other features and advantages, which will become subsequently apparent, reside in the details of construction and operation of the invention as more fully hereinafter described and claimed. In the description, reference is made to the accompanying drawings, which form a part of this document, in which like numerals refer to like parts throughout the several views. The elements shown in the drawings are not necessarily shown to scale, emphasis instead being placed upon illustrating the principles of the invention. Moreover, the depiction of the elements shown in the drawings is not generally to the exclusion of other configurations that can possibly be used for such elements.

### BRIEF DESCRIPTION OF THE DRAWINGS

FIG. 1A is a perspective view of an electro-absorption modulator (EAM);

FIG. 1B shows graphs of intensity versus applied voltage and time, illustrating certain aspects of the operation of an EAM;

FIG. 2 is a block diagram of a disclosed return-to-zero (RZ) pulse generator with variable duty cycle;

FIG. 3 is a flowchart of processing performed to prepare the controller for operation mode;

FIG. 4 is a flowchart of processing performed by a controller of an RZ pulse generator in its operation mode;

FIG. 5 is a block diagram of a return-to-zero (RZ) pulse generator with variable duty cycle and variable chirp compensation;

FIG. 6 is flowchart of processing to store a mapping of delay time τ and voltages V_{φ}, V_{δ} to prepare the controller of the RZ pulse generator to generate variable frequency chirp compensation;

FIG. 7 is a flowchart of processing performed by the controller in generating an optical pulse signal with variable frequency chirp compensation;

FIG. 8 is a block diagram of an NRZ modulator with variable chirp compensation capabilities;

FIGS. 9A and 9B constitute a flowchart indicating operation of the NRZ modulator with variable chirp compensation;

FIG. 10 is a block diagram of an alternative configuration of the NRZ modulator;

FIG. 11 is a block diagram of a return-to-zero (RZ) transmitter with variable duty cycle and optional optical amplification and/or modulation capabilities;

FIG. 12 is a flowchart of a method for determining and storing a mapping of voltage applied to an optical amplifier (OA) versus the gain of the OA resulting from application of such voltage to the OA;

FIG. 13 is a flowchart of processing performed by the RZ transmitter to generate an optically-amplified and/or modulated optical signal;

FIG. 14 is a flowchart of a method for determining and storing a mapping of the clock frequency to the level of a control signal generated by the controller to generate an optical pulse signal at a programmable frequency;

FIG. 15 is a flowchart of a method for generating a variable clock signal;

FIG. 16 is a block diagram of a voltage control unit (VCU);

FIG. 17 is a perspective view of an integrated unit incorporating an EAM and microstrip impedance matching circuit (IMC);

FIG. 18 is a perspective view of an integrated unit incorporating an EAM and coplanar waveguide (CPW) IMC;

FIG. 19 is a perspective view of an integrated unit in which the EAM is configured to form a part of a resonant circuit, and using a tuning section for control of the resonant frequency, for enhancing drive of the EAM;

FIG. 20 is a circuit diagram of the integrated unit of FIG. 19.

FIGS. 21A and 21B are views of an EAM having a multiple quantum well (MQW) active region and a bulk active region, respectively;

FIG. 22A is a perspective view of an integrated unit with EAM and spot-size converters, and FIGS. 22B-22D are cross-sectional views of the integrated unit of FIG. 22A taken at different positions with optical energy distribution superimposed;

FIGS. 23A-23D are top plan views of a selective area regrowth technique applied to the integrated unit;

FIGS. 24A-24D are top plan views of a selective area disordering technique applied the integrated unit; and

FIG. 25 is a block diagram of a 1×N splitter that can be incorporated into the disclosed apparatuses to provide multiple outputs.

### DESCRIPTION OF THE PREFERRED EMBODIMENTS

As used herein, the following terms have the following definitions:

“And/or” means “either or both”.

“Coupled” in an optical sense means joining optical, electro-optical, or opto-electrical devices together so as to permit passing of light from one to another. Optical coupling can be done through any transmissive media, including optical fibers, optical waveguides, air, water, space, optical adhesive, or other media, whether directly or through intermediate device or medium. “Coupled” in an electronic sense refers to joining electronic components together with a conductive line such as a wire or cable, or by transmission of signals through air or other media, or space, for example, whether directly or through intermediate device or medium;

“Downstream” refers to a direction or element that is further along the path of travel of an optical or electrical signal relative to a reference point or element along the path;

“Extinction ratio” is the ratio of maximum power corresponding to a “1” or “on” bit state of an optical signal, and the maximum power corresponding to “0” or “off” state of an optical signal.

“Gain” is a measure of the amount of photons generated by an optical amplifier per unit energy input for their generation;

“Input device” refers to a portion of a controller that can be used to input data into the controller. The input device can be one or more keys, a keyboard, mouse, wand, or combination of these devices defining the portion of a graphical user interface used to input data into the controller. The input device can be used to input commands, one or more control programs, or data into the controller.

“N-type” refers to a semiconductor material doped with donor atoms. The donor atoms can be silicon (Si), or selenium (Se) in the case of gallium arsenide (GaAs)/aluminum gallium arsenide (AlGaAs) semiconductor materials, or Si in the case of the indium phosphide (InP)/indium gallium arsenide phosphide (InGaAsP).

“Radio-frequency (RF)/microwave” refers to a signal in the radio-frequency or microwave range.

“Memory” can be a random-access memory (RAM), read-only memory (ROM), programmable read-only memory (PROM), erasable-electrically-programmable read-only memory (EEPROM), register, or other device. The memory can be addressable by 8-, 16-, 32-, or 64-bit address lines, for examples, and can store 8-, 16-32, 64- or 128-bit data in an amount from may be from byte to Megabyte or more in size.

“Optical waveguide” is used in a very broad sense to refer to any kind of structure or device for guiding optical energy in a signal. Such optical waveguide can be integrated into a semiconductor or other substrate, or may be in the form of an optical fiber, for example.

“Optical data signal” is an optical carrier signal modulated with data.

“Output device” refers to a portion of a controller that can be used to transmit information from the controller to a person operating the controller. The output device can be a cathode ray tube (CRT), liquid crystal display (LCD), flat-panel, or other display.

“Processor” refers to a microprocessor (e.g., Pentium® III microprocessor, Intel® Corporation, Santa Clara, Calif.), a microcontroller (several such units are commercially-available from Motorola® Corporation, Schaumberg, Ill., and others), programmable logic array (PLA), programmable array logic (PAL), field programmable gate array (FPGA), or any other device that can be programmed to generate control signals for use in controlling the disclosed apparatus.

“P-type” refers to a semiconductor material doped with acceptor atoms. The acceptor atoms can be beryllium (Be), magnesium (Mg), zinc (Zn), cadmium (Cd), silicon (Si), carbon (C), or copper (Cu) in the case of gallium arsenide (GaAs)/aluminum gallium arsenide (AlGaAs) semiconductor materials, or Zn, Be, Mg in the case of the indium phosphide (InP)/indium gallium arsenide phosphide (InGaAsP).

“(s)” or “(ies)” means more than one of the preceding object. E.g., “frequency(ies)” means “one or more frequencies.”

“Upstream” refers to a direction or element that is backward relative to the direction of travel of an optical or electrical signal along a transmission path, relative to a reference point or element along the path.

“Variable” is used to refers to a characteristic such as duty cycle, chirp and/or optical amplification, that can be controlled by a controller.

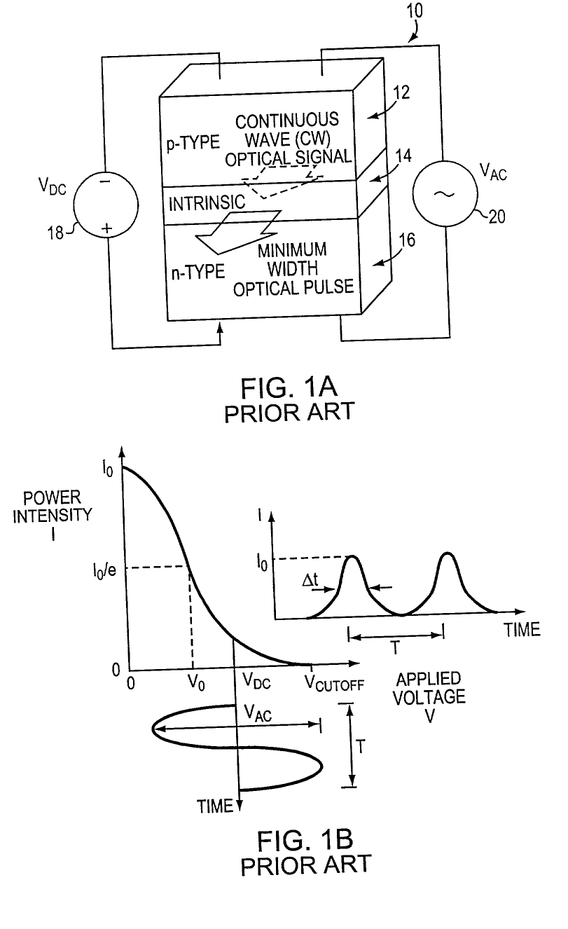

FIG. 1A is a view of an electro-absorption modulator (EAM) 10 that is a basic element of the disclosed apparatuses. The EAM 10 comprises a p-type semiconductor region 12, intrinsic semiconductor region 14, and n-type semiconductor region 16. The p-type semiconductor region 12 is positioned in contact with the intrinsic semiconductor region 14, and the intrinsic semiconductor region is positioned in contact with the n-type semiconductor region 16. The voltage source 18 is coupled to apply a reverse-biased voltage V_{DC} across the semiconductor regions 12, 14, 16, which renders the intrinsic region 14 absorptive to light transmitted through the intrinsic region, in this case, the continuous wave (CW) optical signal. The intrinsic region 14 is absorptive to the CW optical signal by a static amount proportional to the voltage V_{DC}. A voltage source 20 is coupled to apply a time-varying voltage V_{AC} across the semiconductor regions 12, 14, 16. The voltage V_{AC} modulates the CW optical signal by a corresponding time-varying amount. The EAM 10 has previously been used to generate an optical pulse train with a minimum duty cycle from a CW input optical signal.

In FIG. 1B, the intensity I transmitted through the EAM 10 is depicted versus the applied voltage V, which is the combination of voltages V_{DC} and V_{AC}. The maximum intensity I_{O} is output from the EAM 10 when such device absorbs none of the power of the CW optical signal, except for a relatively small amount of intrinsic loss. The voltage V_{O} is the amount of voltage V applied across the EAM 10 that reduces the intensity I_{O} by 1/e. The voltage V_{O} is thus a measure of the amount by which a change in voltage V affects the transmission/absorption of the EAM. The voltage V_{DC} is applied to the EAM 10 and defines its static absorption of the CW optical signal. The time-varying voltage V_{AC} is also applied to the EAM 10, so that the voltage V applied to the EAM 10 is the combination of voltages V_{AC} and V_{DC}. As the voltage V_{AC} cycles through first negative part of its period T, the voltage V applied to the EAM 10 is reduced until it reaches a minimum at V_{DC}−V_{AC} corresponding to the peak power of the optical signal output by the EAM 10. If V_{AC}≧V_{DC}, the intensity becomes saturated at I_{O}. Conversely, as the voltage V_{AC} cycles through the positive half of its cycle, the voltage V applied to the EAM 10 reaches a maximum at V_{DC}+V_{AC}. At this part of the period T of the voltage V_{AC}, the absorption of the CW optical signal by the EAM 10 is maximized, and the power of the optical signal output from the EAM 10 is a minimum. V_{CUTOFF} corresponds to the voltage at which the EAM 10 totally absorbs the CW optical signal. Accordingly, if V_{DC}+V_{AC}≧V_{CUTOFF}, the power intensity I will be totally absorbed by the EAM 10. The periodic voltage V_{AC} thus results in generation of optical pulses with corresponding period T. The duty cycle of the optical pulses generated by the EAM 10 is defined as the full width at one-half the maximum power intensity of the pulses, Δt, divided by the period of the optical pulse signal, T.

### 1. Return-to-Zero Pulse Generator

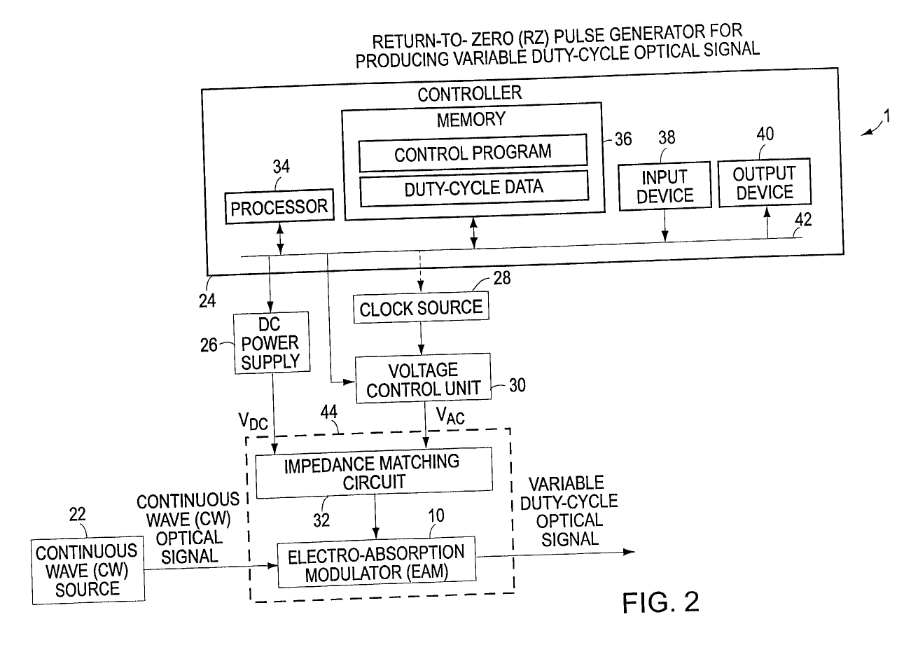

In FIG. 2, an apparatus 1 comprises an EAM 10, a continuous wave (CW) source 22 that generates a CW optical signal, a controller 24, a DC power supply 26, a clock source 28, a voltage control unit (VCU) 30, and an impedance matching circuit (IMC) 32. The controller 24 comprises a processor 34, a memory 36, an input device 38, and an output device 40 coupled via bus 42. The memory 36 is loaded with a control program that the processor 34 executes to permit the controller 24 to be programmed by a person in preparation for operation of the apparatus 1. The processor 34 also executes the control program to control the EAM 10 in the apparatus's operation mode. The control program can be preloaded in the apparatus 1 prior to use, or may be input by a person at the time the controller 24 is programmed for operation. A person can also use the input device 38 to provide the controller 24 with a mapping of data indicating duty cycle of an optical signal to be generated by the apparatus 1, and corresponding data indicating respective magnitudes of voltages V_{DC} and V_{AC} that the controller 24 is to use to generate the optical signal with the duty cycle indicated by the user. A person can use the input device 38 to enter a command to the processor 34 to execute its control program. A person can also use the input device 38 to input data indicating the duty cycle of the optical signal that is to be generated by the apparatus 1. In executing the control program, the processor 34 uses the duty cycle data input by the user to retrieve data from the memory 34 that indicates the magnitudes of corresponding voltages V_{DC} and V_{AC} to be used by the apparatus 1 for generating the optical signal with the designated duty cycle. The processor 34 is coupled via bus 42 to supply the signal indicating the magnitude of the voltage V_{DC} to the DC power supply 26, and the DC power supply 26 generates the voltage V_{DC} based on the signal from the controller 24. The controller 24 is also coupled to supply the signal indicating the magnitude of the voltage V_{AC} to the VCU 30. The VCU 30 is also coupled to receive a clock signal generated by the clock source 28, optionally under control of the processor 34. The VCU 30 generates the voltage V_{AC} based on the signals from the controller 24 and the clock source 28. More specifically, the VCU 30 generates the voltage V_{AC} with the magnitude determined by the control signal from the controller 24, and a frequency determined by the frequency of the clock signal. The DC power supply 26 and the VCU 30 are coupled to supply respective voltages V_{DC} and V_{AC} to the impedance matching circuit (IMC) 32. The IMC 32 transfers the voltages V_{DC} and V_{AC} to the EAM 10 so as to reduce the amount of reflection from the EAM 10 by matching the input impedance of the EAM 10 to the output impedance of the VCU 30. The IMC 32 can be tuned to the frequency of the clock signal, for example. The CW source 22 generates a CW optical signal, and the EAM 10 is coupled to receive the CW optical signal from the CW source 22. Based on the voltages V_{DC}, V_{AC}, and the CW signal, the EAM 10 generates a variable duty-cycle optical signal. As shown in FIG. 2 the IMC 32 and EAM 10 can be formed together on a substrate as an integrated unit 44.

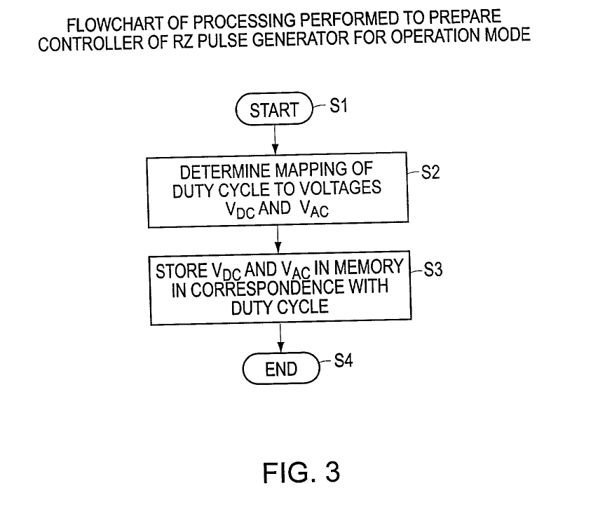

The ability to control the duty-cycle of an optical pulse signal is becoming increasingly important in transmission of optical signals, particularly over relatively long distances on the order of one-hundred kilometers or more. As the duty cycle is decreased, pulse distortion due to self-phase modulation and cross-phase modulation of optical fibers is reduced as previously described. However, as the duty cycle is decreased, the spectral width of the pulse is increased, leading to increased pulse spreading due to dispersion. The duty cycle can be adjusted according to the nonlinear and dispersion characteristics of the fiber at the particular transmission wavelength to improve the ability to detect the pulses at a receiver after transmission. Testing and modeling of an optical network system can be performed to determine the duty-cycle yielding improved or optimal results, and such duty cycle can be programmed into the controller 24. FIG. 3 is a flowchart indicating processing performed by a person using the controller 24 to prepare the controller for its operational mode. In step S1 the method begins. In step S2 the person determines the duty cycle versus magnitudes of voltages V_{DC} and V_{AC} that yield such duty cycle if applied to the IMC 32 and EAM 10. This can be done be determining magnitudes of voltages V_{DC} and V_{AC} at intervals of the duty cycle, e.g., in 1% increments, for duty cycles from 0-100%. The resulting duty cycle data can be used by the processor 34 to generate signals indicating the magnitudes of the voltages V_{DC} and V_{AC} upon the user's specification of the duty cycle via the input device 38. In step S4 the method of FIG. 3 ends.

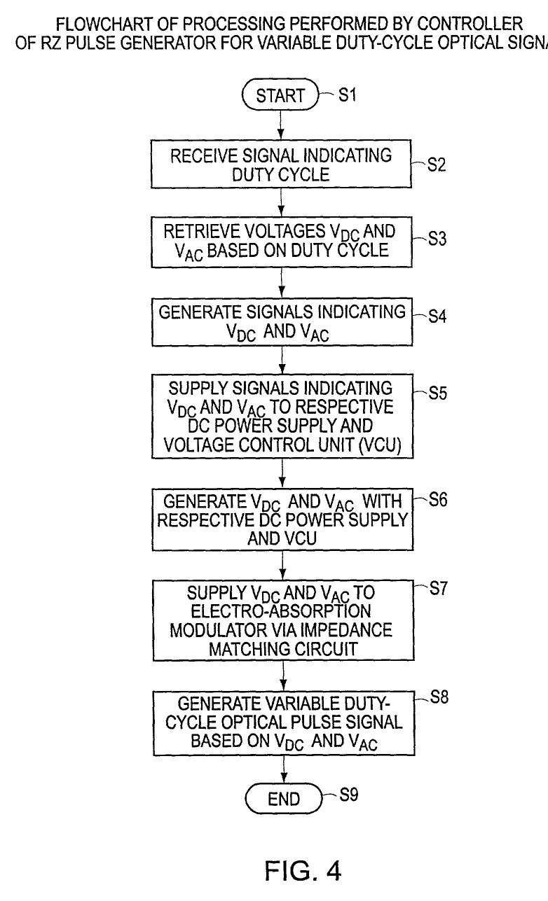

FIG. 4 is a flowchart of processing performed by a person and the controller 24, or more specifically the processor 34, in the operation mode of the apparatus 1 of FIG. 2. In step S1 the method of FIG. 4 begins. In step S2 the processor 34 receives via the input device 38 and bus 42 a signal(s) indicating the duty cycle of the optical signal to be generated by the apparatus 1. In step S3 the controller 24 determines the magnitudes of the voltages V_{DC} and V_{AC} based on the received duty cycle. More specifically, the processor 34 uses the received duty cycle to reference the memory 36 to retrieve the data indicating the magnitudes of the voltages V_{DC} and V_{AC}. In step S4 the controller 24 generates signals indicating the magnitudes of the voltages V_{DC} and V_{AC} using the retrieved data. In step S5 the processor 34 supplies the signals data indicating the magnitudes of the voltages V_{DC} and V_{AC} to the DC power supply 26 and the VCU 30, respectively. In step S6 the DC power supply 26 and the VCU 30 generate respective voltages V_{DC} and V_{AC}. In the apparatus 1, the DC power supply 26 generates the voltage V_{DC} based on the control signal indicating the magnitude of such DC voltage from the controller 24, and the VCU 30 generates the voltage V_{AC} based on the control signal indicating the magnitude of such AC voltage from the controller 24 as well as the clock signal generated by the clock source 28. In step S7 the DC power supply 26 and the VCU 30 supply respective voltages V_{DC} and V_{AC} to the EAM 10 via the IMC 32. In step S8 the EAM 10 generates the variable duty cycle optical signal based on the optical CW signal generated by the source 22 as well as the voltages V_{DC} and V_{AC}. In step S9 the method of FIG. 4 ends.

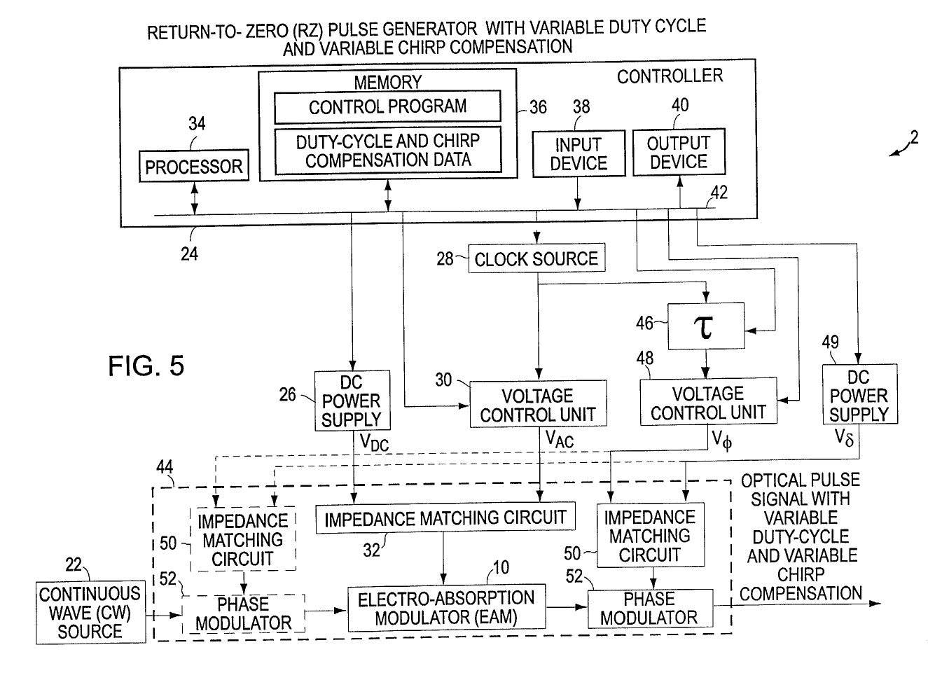

FIG. 5 is an apparatus 2 that is similar in configuration and operation to the apparatus 1 of FIG. 2, with the additional capability to compensate for chirp in the variable duty-cycle optical signal. In addition to the elements previously described for the apparatus 1 with reference to FIG. 2, the apparatus 2 of FIG. 5 comprises a delay unit 46, VCU 48, DC power supply 49, IMC 50, and phase modulator 52. A person can use the input device 38 to store the mapping between data indicating the delay time τ and magnitudes of voltages V_{φ} and voltage V_{δ}, and the corresponding chirp amount, by supplying such data to the controller 24. The processor 34 receives this data via bus 42 and stores this data in the memory 36. The data indicating the delay time τ and magnitudes of voltages V_{φ}, V_{δ} are used in the apparatus of FIG. 5 to generate a voltage V=V_{φ} cos [ω(t−τ)]+V_{δ} that is used to produce the chirp compensation to be imposed on to the variable duty-cycle optical signal produced by the apparatus 2. In operation mode, the processor 34 retrieves the data indicating the delay time τ and voltages V_{φ}, V_{δ} from the memory 36 and generates control signals based thereon. The processor 34 is coupled to supply these signals to the delay unit 46, VCU 48, and DC power supply 49, respectively, via the bus 42. The delay unit 46 is coupled to receive the clock signal from the clock source 28 and generates a delayed version of the clock signal. The unit 46 is coupled to supply the delayed version of the clock signal to the VCU 48. The VCU 48 uses the delayed clock signal and the signal indicating the magnitude of the voltage V_{φ} to generate a delayed signal with amplitude defined by the voltage V_{φ}, i.e., V_{φ} cos [ω(t−τ)] The VCU 48 is coupled to supply this signal to the IMC 50. The DC power supply 49 generates the voltage V_{δ} based on the control signal indicating the magnitude of this voltage from the controller 24. The DC power supply 49 is coupled to supply this voltage V_{δ} to the impedance matching circuit 50 that adds this signal to that from the VCU 48. The IMC 50 supplies the signals from the VCU 48 and the DC power supply 49, to the phase modulator (PM) 52. The PM 52 is coupled to receive the variable duty-cycle optical signal generated by the EAM 10, and generates a phase modulation and associated frequency chirp onto the received variable duty-cycle optical signal using the signals from the from the VCU 48 and the DC power supply 49. The resulting optical pulse signal generated by the apparatus 2 of FIG. 5 has variable duty cycle and variable chirp compensation.

As shown in FIG. 5, any or all of the EAM 10, the IMCs 32, 50, and the PM 52 can be integrated together on a substrate as the unit 44. Also, as shown in broken line in FIG. 5, the PM 52 can be positioned upstream of the EAM 10 so that the PM 52 is coupled to receive the CW optical signal from the source 22, provides a phase modulation and associated frequency chirp on the CW optical signal from the source 22, and is coupled to supply the chirped CW signal to the EAM 10. In this variation, the EAM 10 generates the optical pulse signal with variable duty-cycle and chirp compensation, and can be coupled to supply this signal to a downstream element.

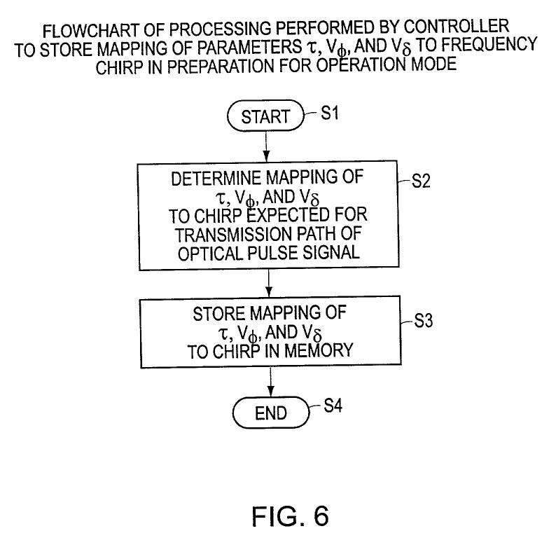

FIG. 6 is a flowchart of a method for preparing the controller 24 for operation mode to provide chirp compensation to an optical signal. In step S1 the method of FIG. 6 begins. In step S2 a mapping of frequency chirp amount for the optical signal to the delay time τ and magnitudes of voltages V_{φ}, V_{δ} is determined. In step S3 a person can input the mapping of parameters τ, V_{φ}, V_{δ} to the frequency chirp amount into the memory 36 via the input device 38 and bus 42 under control of the processor 36. In step S3 the processor 24 receives the mapping between data indicating the delay time τ, voltage V_{φ}, and voltage V_{δ}, and the chirp amount, and stores such data in the memory 36. In step S4 the method of FIG. 6 ends.

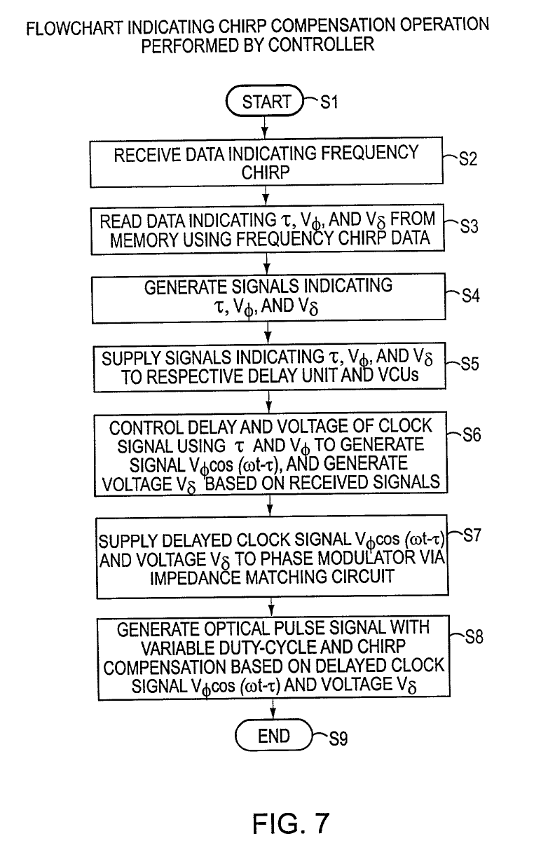

FIG. 7 is a method performed by the apparatus 2 in its operational mode to provide chirp compensation for an optical signal generated by the apparatus 2 of FIG. 5. The method begins in step S1. In step S2 the processor 34 receives from the input device 28 data indicating the frequency chirp to be induced onto the optical signal generated by the apparatus 2. In step S3 the processor 34 reads via the bus 42 data indicating the delay time τ and respective magnitudes of voltages V_{φ}, V_{δ} from the memory 36 corresponding to the received frequency chirp data. In step S4 the processor 24 generates control signals indicating the delay time τ and magnitudes of voltages V_{φ}, V_{δ}, based on the data retrieved from the memory 36. In step S5 the processor 34 supplies the control signals indicating the delay time τ and magnitudes of voltages V_{φ}, V_{δ} to the delay unit 46, the VCU 48, and the DC power supply 49, respectively. In step S6 the units 46, 48, 49 generate respective signals to control the delay and DC and AC voltages of the clock signal. In step S7 the VCU 30 supplies the delayed clock signal to the IMC 50, and the DC power supply 49 supplies the DC voltage V_{δ} to the IMC 49. The received signals are combined by the IMC 50 to generate the signal V=V_{φ}cos [ω(t−τ)]+V_{δ}. In step S8 the apparatus 2 generates the optical pulse signal with a variable duty cycle and a variable chirp based on delayed clock signal V_{φ} cos [ω(t−τ)] and the voltage V_{δ}. In step S8 the method of FIG. 7 ends.

### 2. Non-Return-to-Zero (NRZ) Modulator

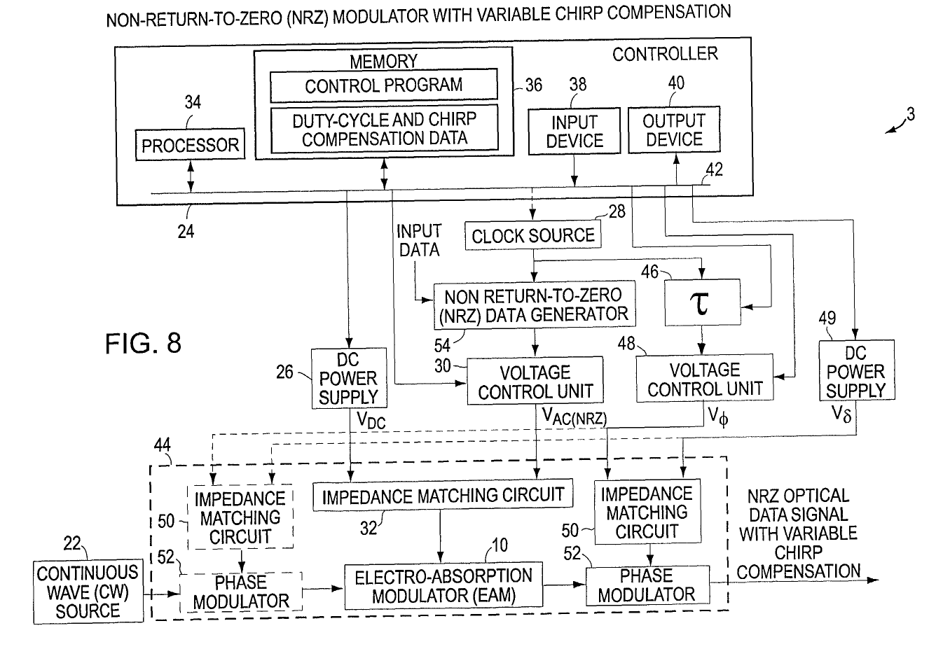

FIG. 8 is a non-return-to-zero (NRZ) modulator 3 with variable chirp compensation for modulating NRZ data on an optical signal. The apparatus 3 of FIG. 8 is similar to that of FIG. 5, with the exception that the apparatus 3 of FIG. 8 comprises an NRZ data generator 54 coupled to receive input data to be modulated onto the optical carrier, as well as the clock signal from the clock source 28. Duty cycle is not relevant to an NRZ optical data signal which has the same state throughout a pulse period. However, the magnitudes of the voltages V_{DC} and V_{AC(NRZ)} can be used to provide a variable extinction ratio (ER) between zero “0” and “1” bit states of the optical data signal in a manner similar to that previously described with respect to the duty cycle for the apparatus 1 of FIG. 2. The NRZ modulator 3 can thus be used to generate control signals indicating the magnitudes of the voltages V_{DC} and V_{AC} to vary the extinction ratio of the optical signal.

The NRZ data generator 54 converts the input data into the NRZ format at the rate of the clock signal. The NRZ data generator 54 is coupled to supply the data signal in the NRZ format to the VCU 30. In other respects the operation of the apparatus 3 of FIG. 8 is similar to that of FIG. 5. Specifically, the VCU 30 controls the voltage level V_{AC(NRZ)} of the NRZ data signal, and supplies the resulting signal to the IMC 32. The IMC 32 can be used for impedance matching over a relatively broad range of frequencies of the optical data signal, or may be tuned to the frequency of the clock signal. The IMC 32 is coupled to receive the voltage V_{DC} from the DC power supply 26, and combines this voltage with the signal from the VCU 30, and supplies the resulting signal to the EAM 10 to produce an optical signal modulated by the NRZ data signal. The EAM 10 is coupled to supply the NRZ optical data signal to the PM 52. The PM 52 is coupled to receive the chirp compensation signal V=V_{φ} cos [ω(t−τ)]+V_{δ}. The PM 52 provides a phase modulation and associated frequency chirp onto the NRZ optical data signal to produce an NRZ optical data signal with variable chirp. The apparatus 3 of FIG. 8 can be coupled to supply the produced signal to a downstream element. As indicated by broken line in FIG. 8, the PM 52 can be coupled upstream of the EAM 10. More specifically, the PM 52 can be coupled to receive the optical CW signal from the source 22, and can provide frequency chirp to the optical CW signal based on the signals from the VCU 48 and the DC power supply 49. The PM 52 can be coupled to supply the chirped CW signal to the EAM 10 for modulation with NRZ data with variable duty cycle.

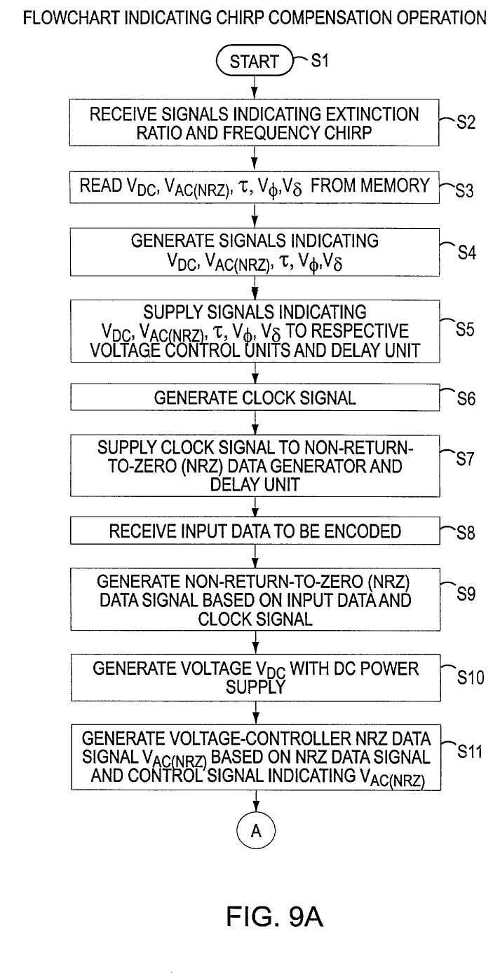

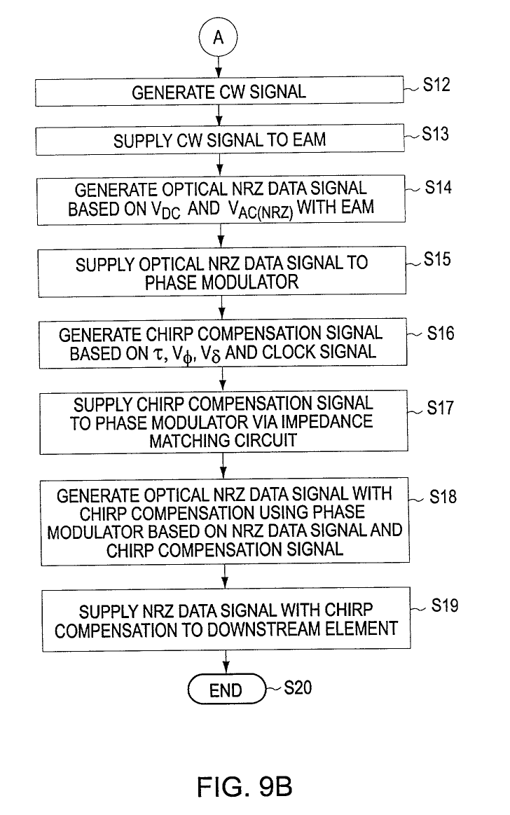

FIGS. 9A and 9B are a flowchart of processing performed by the NRZ modulator 3 of FIG. 8 in the generation of an NRZ optical data signal with variable chirp. In step S1 the method of FIGS. 9A and 9B begin. In step S2 the processor 24 receives signals indicating the extinction ratio and the frequency chirp from the input device 38 via the bus 42. In step S3 the processor 34 of the controller 24 reads data indicating the parameters V_{DC}, V_{AC(NRZ)}, τ, V_{φ}, and V_{δ} from the memory 36 corresponding to the extinction ratio and frequency chirp indicated by the received signals. In step S4 the processor 34 uses the retrieved data to generate signals indicating the parameters V_{DC}, V_{AC(NRZ)} to control extinction ratio, and τ, V_{φ}, and V_{δ} to control chirp compensation. In step S5 the processor 34 supplies the signals indicating the parameters V_{DC}, V_{AC}, τ, V_{φ}, and V_{δ} to the DC power supply 26, the VCU 30, the delay unit 46, the VCU 48, and the DC power supply 49, respectively. In step S6 the clock source 28 generates the clock signal. In step S7 the clock source 28 supplies the clock signal to the NRZ data generator 54 and the delay unit 46. In step S8 the NRZ data generator 54 receives the input data to be modulated onto an optical carrier. In step S9 the NRZ data generator 54 generates the NRZ data signal at the bit rate of the clock signal frequency based on the input data. In step S10 the power supply 26 and the VCU 30 generates respective voltages V_{DC} and V_{AC(NRZ)} based on the signals supplied by the controller 24. In step S11 the power supply 26 and VCU 30 supply the voltages V_{DC} and V_{AC(NRZ)} to the EAM 10 via the IMC 32. In step S12 of FIG. 9B, the CW source 22 generates the optical CW signal. In step S13 the CW source 22 supplies the optical CW signal to the EAM 10. In step S14 the EAM 10 generates the optical NRZ data signal based on the voltages V_{DC} and V_{AC(NRZ)} and the optical CW signal from the CW source 22. The optical NRZ data signal has an extinction ratio defined by the voltages V_{DC} and V_{AC(NRZ)}. In step S15 the EAM 10 supplies the optical NRZ data signal to the PM 52. In step S16 the clock source 28, delay unit 46, VCUs 30, 48, DC power supply 49, and supply to IMC 50 generate the voltage signal V=V_{φ} cos [ω(t−τ)]+V_{δ} for chirp compensation. In step S17 the IMC 50 supplies the voltage signal to the PM 52. The PM 52 provides a phase modulation and associated frequency chirp on to the optical NRZ data signal from the EAM 10. In step S19 the PM 52 supplies the NRZ optical signal with variable chirp to a downstream element. In step S20 the method of FIGS. 9A and 9B ends.

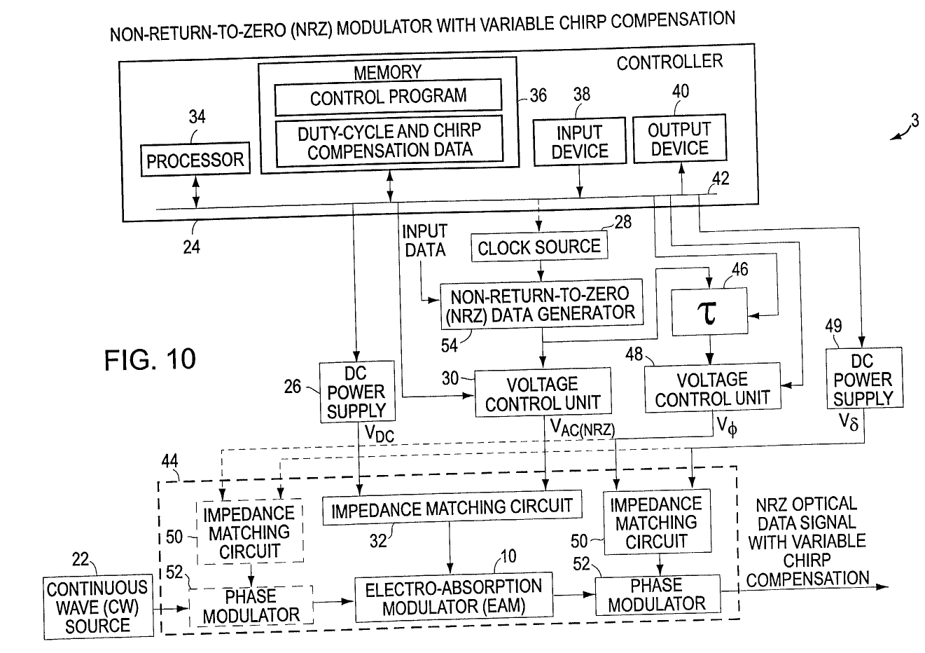

FIG. 10 is an alternative version of the apparatus 3 of FIG. 8. In the apparatus 3 of FIG. 10 the NRZ data generator 54 is coupled to supply the NRZ data signal to the delay unit 46. The NRZ data signal in FIG. 8 is thus input to the delay unit 46 in replacement of the clock signal in the apparatus of FIG. 10. The chirp compensation provided by the apparatus 10 is thus performed based on the NRZ data as opposed to the clock signal. Further details of the construction and operation of the apparatus 3 of FIG. 10 are similar to those of FIG. 8.

### 3. Return-to-Zero (RZ) Transmitter

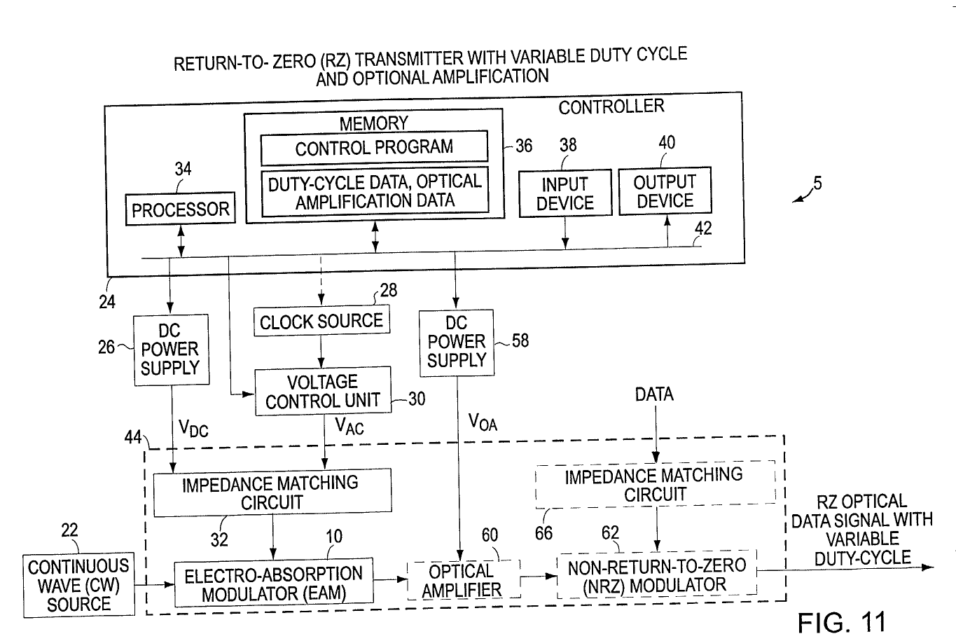

FIG. 11 is a return-to-zero (RZ) transmitter 5 optionally with optical amplification to produce an RZ optical data signal with variable duty cycle. Although not shown in FIG. 11, the RZ transmitter 5 can have the capability to produce variable chirp using the PM 52 and associated elements. The RZ transmitter 5 of FIG. 11 is similar in many respects to the RZ pulse generator 1 of FIG. 2, with the addition of the DC power supply 58, the optical amplifier (OA) 60, and/or NRZ modulator 62 and respective IMC 66. The input device 38 can be used to program the controller 36 with optical amplification data. More specifically, a person can use the input device 38 to supply the processor 34 with a mapping between data indicating the gain of the OA and the voltage V_{OA} to be applied to the OA 60 via the bus 42. The processor 34 stores this mapping in the memory 36. In the operation mode, the processor 34 retrieves data indicating the voltage V_{OA} using this mapping. The processor 34 uses the retrieved data to generate a signal indicating the voltage V_{OA}. The processor 34 is coupled via the bus 42 to supply the signal indicating the voltage V_{OA} to the VCU 58. The VCU 58 generates the voltage V_{OA} based on the received signal, and is coupled to supply the voltage V_{OA} to the OA 60. The OA 60 is coupled to receive the duty-cycle-controlled optical signal from the EAM 10, and amplifies this signal based on the voltage V_{OA}.

The NRZ modulator 62 can be coupled to receive the optically-amplified signal from the OA 60, or if the OA 60 is not used, can be coupled to the EAM 10. The NRZ modulator 62 is coupled to receive data via the IMC 66, and modulates the RZ pulse train from units 10 and/or 60 based on the received data. Although not shown in FIG. 11, the optical amplifier 60 can be positioned downstream of the NRZ modulator 62, and coupled to receive an RZ optical data signal therefrom. The OA 60 can amplify the RZ optical data signal based on the voltage V_{OA}.

As shown in FIG. 11, the EAM 10, OA 60, and/or NRZ modulator 62 and respective IMCs 32, 62 can be integrated together on the unit 44.

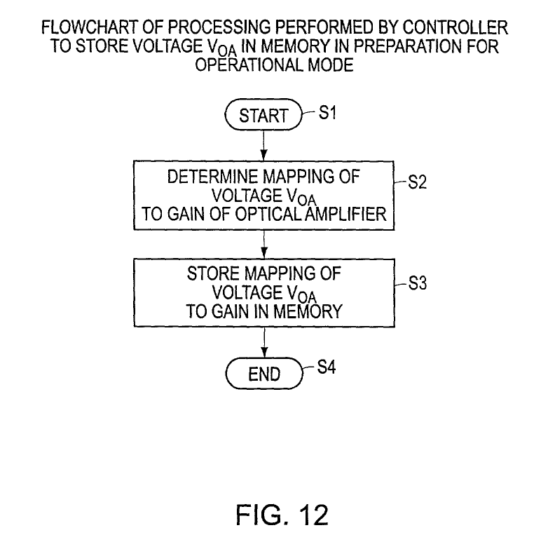

FIG. 12 is a flowchart of processing performed by the controller 24 of the RZ transmitter 5 of FIG. 11 to store a mapping of the magnitude of the voltage V_{OA} to the average power of the optical signal in the memory 36 in preparation for its operational mode. In step S1 the method of FIG. 1 begins. In step S2 the mapping of data indicating the voltage V_{OA} to the data indicating the amount of amplification of the optical signal (i.e. the gain of the OA) is determined. For example, this can be done in increments of one-tenth (0.1) Volt over a range from zero to five (0-5) Volts. The corresponding intensity produced by the RZ transmitter 5 under ranges of the voltage V_{OA} can be stored in the memory 36 in correspondence with resulting power measurements of the optical pulse signal expressed milliwatts or other units. In step S3 the mapping of data indicating the voltage V_{OA} is stored in the memory 36 in correspondence with respective power measurements. In step S4 the method of FIG. 12 ends.

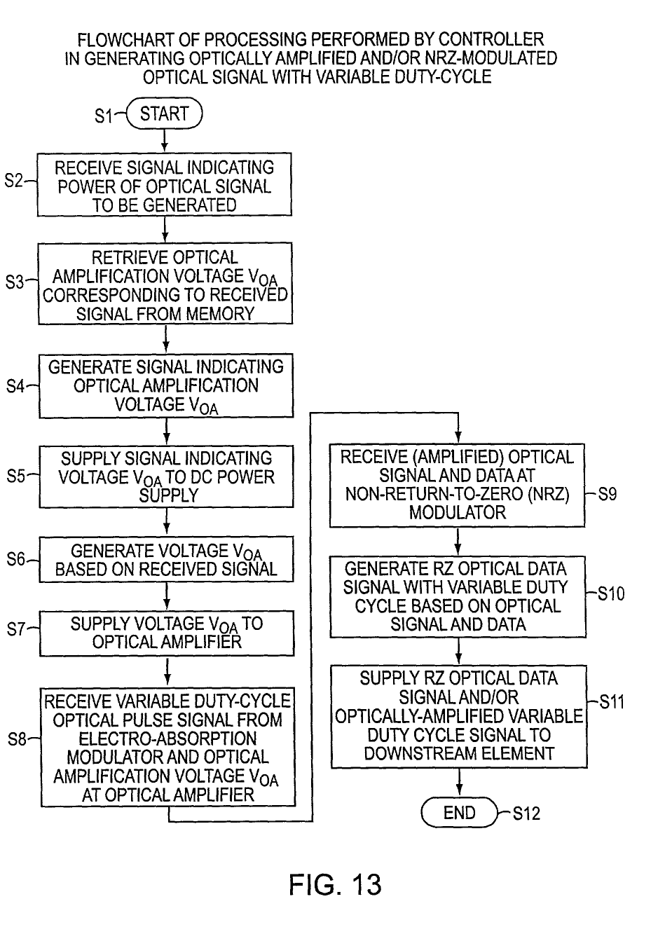

FIG. 13 is a flowchart of processing performed by the controller 24 in generating the optically-amplified RZ optical data signal with variable duty cycle. In step S1 the method of FIG. 13 begins. In step S2 the processor 34 receives a signal indicating the power of light to be output by the RZ transmitter 5 based on the power of the CW input. In step S3 the processor 34 uses the received signal to retrieve data indicating the magnitude of the voltage V_{OA} from the memory 36. In step S4 the processor 34 generates a signal indicating the optical amplification voltage V_{OA} based on the data retrieved from the memory 36. In step S5 the processor 34 supplies the signal indicating the voltage V_{OA} to the DC power supply 58. In step S6 the DC power supply 58 generates the voltage V_{OA} based on the signal received from the controller 24. In step S7 the DC power supply 58 supplies the voltage V_{OA} to the optical amplifier 60. In step S8 the OA 60 receives the variable duty-cycle optical pulse signal from the EAM 10 and the optical amplification voltage V_{OA} from the VCU 58. In step S9 the OA 60 generates an amplified optical pulse signal based on the signals from the EAM 10 and the VCU 58. In step S10 the NRZ modulator 62 receives the optical signal from the EAM 10 and/or the OA 60. The NRZ modulator 62 is also coupled to receive data via the IMC 66. In step S10 the NRZ modulator generates a RZ optical data signal with variable duty cycle. In step S11 the NRZ modulator supplies the RZ optical data signal with variable-duty cycle, whose average power may be regulated by the OA, to a downstream element. In step S12 the method of FIG. 13 ends.

Although in FIGS. 12 and 13 the voltage V_{OA} is stored in the controller 24 for use in amplifying the optical data signal, for current-driven optical amplifiers, current I_{OA} can be used instead of the voltage V_{OA}. In this variation of the apparatus 5, the DC power supply 58 can be replaced with a current source controlled by the controller 24 using a mapping of data indicating current and power stored in the memory 36.

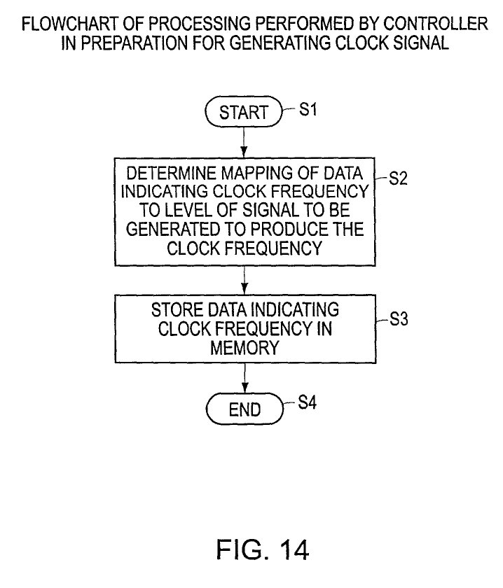

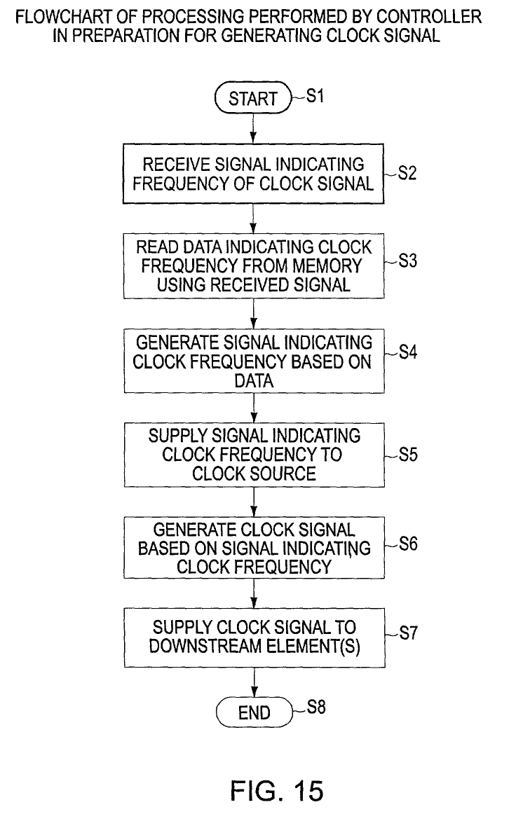

FIGS. 14 and 15 are flowcharts related to variably controlling the frequency of the clock signal used by the apparatuses of FIGS. 2, 5, 8, 10, and 11, for example. More specifically, FIG. 14 is a flowchart of processing performed by the controller 24 to prepare for the generation of a clock signal in its operation mode. In step S1 the method of FIG. 15 begins. In step S2 a mapping of data indicating the clock frequency to the level of the signal to be generated by the controller 24 and supplied to the clock source 28 to attain that frequency. The mapping can be determined experimentally by determining signal levels producing target frequencies of the clock signal generated by the clock source 28. The target frequencies can be those established by standards organizations such as the Institute for Electrical and Electronic Engineers for optical carrier signals, for example, and may be at set frequencies in the range from ten (10) to forty (40) gigahertz. In step S3 the processor 34 stores in the memory 36 the mapping of the data indicating the clock frequency in correspondence with data indicating respective signal levels designating such frequency as generated by the input device 28. In step S4 the method of FIG. 14 ends.

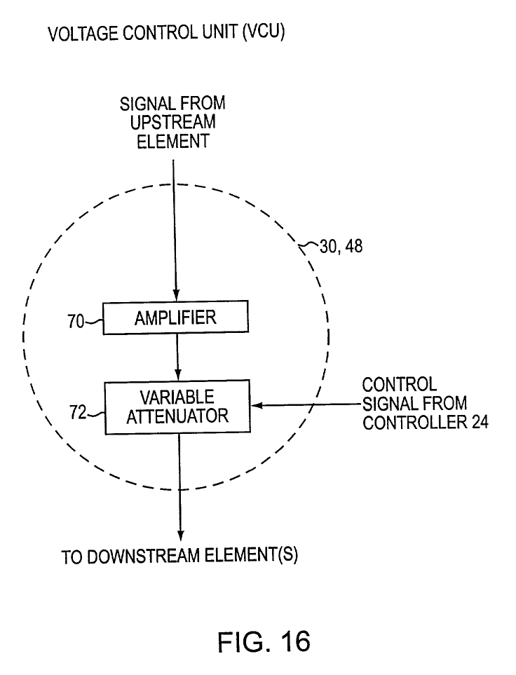

FIG. 15 is the operation mode of controller 24 of any of the apparatuses of FIGS. 2, 5, 8, 10, and 11, for example, in controlling the clock source to generate a clock signal with variable frequency. The clock source 28 can be implemented as a voltage-controlled oscillator (VCO), for example. In step S1 the method of FIG. 16 begins. In step S2 the processor 34 receives a signal indicating the frequency of the clock signal to be used by the apparatus from the input device 38. In step S3 the processor 34 reads data corresponding to the signal level received from the input device 38. In step S4 the processor generates a signal indicating the designated frequency based on the retrieved data. In step S5 the processor 34 supplies the signal indicating the frequency of the clock signal to the clock source 28. In step S6 the clock source 28 generates the clock signal based on the signal indicating the clock frequency from the controller 24. In step 76 the clock source 28 supplies the clock signal to a downstream element(s). In step S8 the method of FIG. 15 ends.

FIG. 16 is a relatively detailed view of a VCU such as units 30, 48 of the apparatuses of FIGS. 2, 5, 8, 10, and 11, for example. The VCU can comprise an amplifier 70 and a variable attenuator 72. The amplifier 70 is coupled to receive a signal from an upstream element. The amplifier 70 is coupled to supply the amplified signal to the variable attenuator 72. The variable attenuator 72 is coupled to receive a control signal from the controller 24 and attenuates the amplified signal based on the control signal. The variable attenuator 72 is coupled to supply the attenuated signal to a downstream element. The RZ pulse generators of FIGS. 2 and 5, the NRZ modulator of FIGS. 8, 10, or the RZ transmitter of FIG. 11 can be provided with the capability to generate a clock signal with variable frequency.

### 4. Integrated Unit

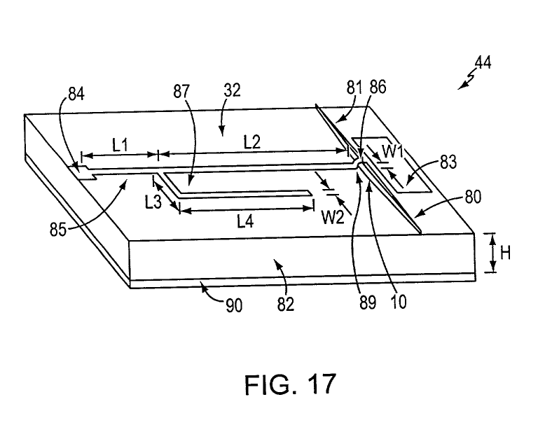

FIG. 17 is a view of an integrated circuit 44 that comprises the EAM 10 and the IMC 32. In FIG. 17, the IMC 18 is implemented using a radio-frequency (RF)/microwave microstrip circuit. The EAM 10 is optically-coupled to spot size converters 80, 81 that convert the spot size of the light traveling in the EAM 10 to a size compatible with an optical fiber or other coupling medium so as to reduce the coupling loss for the EAM to optical fibers and/or other elements. As shown in FIG. 17, the EAM 10, spot-size converters 80, 81, and IMC 32, are formed on semi-insulating substrate 82. The EAM 10 is disposed adjacent a contact pad 83, and on the opposite side of the EAM 10, the IMC 32 is positioned. The IMC 32 comprises a contact pad 84, coupled transmission lines 85, 87, and a conductive bridge 89 electrically coupled to the electrode 86 of the EAM 10. These elements are described in further detail below.

The EAM 10 can be composed of several epitaxial layers formed on semi-insulating substrate 82 composed of indium phosphide (InP), for example. The epitaxial layers can be grown by metal organic chemical vapor deposition (MOCVD) or gas-source molecular beam epitaxy on a commercially available substrate 82. The final material structure of the integrated device 44 can be achieved in a single epitaxial run followed by material process, or alternatively multiple epitaxial runs.

The layers forming the EAM 10 of the integrated device 44 should satisfy the following criteria: (a) there should be an n-layer of InP (not shown) provided under the n-contact layer 83; (b) the waveguiding region of the EAM 10 should of course guide the light to be modulated at the wavelength of that light (e.g. 1.55 μm), (c) the EAM 10 should have an energy bandgap appropriate for electroabsorption modulation of the optical light (generally, the bandgap energy of the EAM 10 should be greater than that of the optical signal traveling therethrough); and (d) a p-contact layer should be provided under the electrode 86. The IMC 32 has several sections of RF/microwave transmission lines 85, 87 that define passive elements such as capacitors, inductors, and resistors. The transmission lines 85, 87 have electrodes that are made of highly conductive metal films. The electrodes are deposited on the semi-insulating substrate 82. The integration of the IMC 32 and the EAM 10 as shown in FIG. 17 avoids the inclusion of parasitic passive elements that can affect the performance the resonant circuit. The transmission lines 85, 87 are electrically-coupled to the EAM 10 via metal-bridge 89.

The spot-size converters (SSC) 80, 81 comprise a tapered waveguiding region for coupling light between an optical fiber (not shown) and the EAM 10. The SSCs 80, 81 have relatively high coupling efficiency to a single mode optical fiber, whether as-cleaved or lensed, and has relatively low propagation loss for the optical light to be modulated. The SSCs 80, 81 also couple light with relatively high efficiency (>99%) to the waveguide region of the EAM section 10 of the integrated device 44.

In the following, a representative fabrication sequence is described for the case in which a single epitaxial run is utilized. There can be additional material processing steps for the spot-size converter regions 80, 81 as described in a subsequent section.

After the material structure is completed, a typical fabrication process sequence of the wafer is described as follows:

(i) Fabrication of p-electrode 86 on the EAM waveguide. This step is typically done using a lift-off technique in which mask openings [the mask can be commercially available photo-resist and/or polymethyl methacrylate (PMMA)] are formed over the electrode region of the EAM 10, followed by thermal deposition or electron beam evaporation of contact metals (e.g. Ti/Pt/Au, 100 Å/1000 Å/1000 Å) that can adhere well to the top layer of the EAM 10 (e.g. heavily doped InGaAs layer, 200-500 Å in thickness) forming a relatively low resistivity ohmic contact (i.e., contact resistivity less than 10⁶ Ω-cm). After deposition, the masking materials are removed, leaving behind the metal strips. The metals are annealed in an inert ambient of forming gas (5% hydrogen in 95% nitrogen) at around 320-340° C. to sinter the contact.

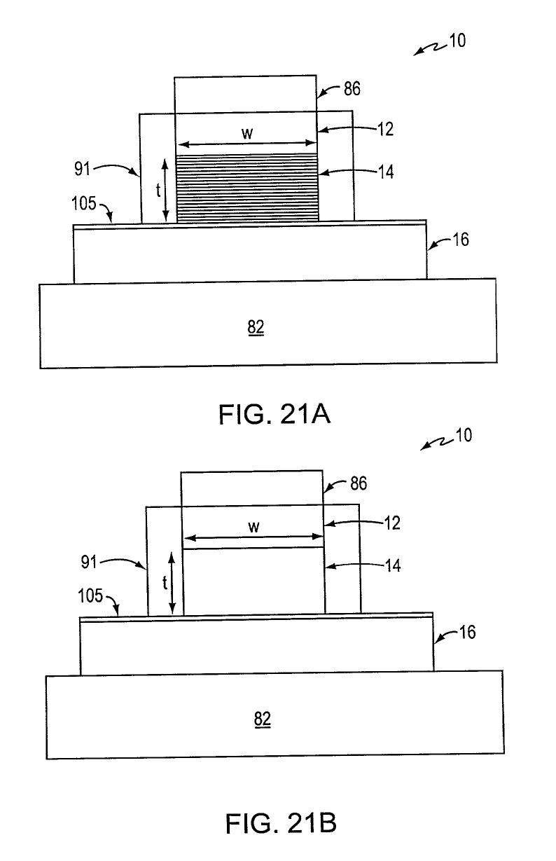

(ii) Mesa formation for the EAM 10 and spot-size converters (SSCs) 80,81. This step can be performed using either wet chemical etching or dry etching steps using a mask (the lift-off mask can be commercially available photoresist). For the case of wet chemical etching, there are numerous types of commercially-available etchants, selective and non-selective, that can be used to remove the epitaxial layers (“epilayers”). The first etching step can stop at the bottom of the cladding layer 16 (see FIGS. 21A and 21B). An etch-stop layer is used in the case of selective etching. The etching mask is removed. The first etching is followed by passivation step (see item (iii) below). A new mask is applied for the second etching. At the end of the etching step for the second mesa composed of layers 12, 14, the cross-section of the EAM 10 as shown in FIGS. 21A and 21B is obtained. The EAM 10 is within the lower mesa and the optical mode is located near the region of the lower mesa underneath the upper mesa. The width of the lower mesa at the EA waveguide section is determined by the extent of n-contact region (for low ohmic resistance); while the width of the lower mesa at the mode-size converter regions is determined by the waveguide coupling to the fiber (e.g. 8-9 μm for cleaved single fiber).

(iii) Passivation of the EAM 10 and the spot-size converters 80, 81. After the etching step for the upper mesa composed of layers 12, 14, the sidewall of the upper mesa and the part of the top surface at the lower mesa composed of layer 16 in the vicinity of the sidewall of the upper mesa, are protected by a dielectric (e.g. silicon dioxide and silicon nitride) film and/or polyimide film 91. The dielectric film 91 can be deposited via chemical vapor deposition and has a thickness sufficient to insulate the EAM 10 and protect it from the ambient environment, and is generally at least one micron in thickness.

(iv) Fabrication of n-electrode 83 on the EAM 10. This step can be performed using a lift-off technique in which mask openings (the mask can be commercially available photoresist and/or PMMA) are made on top of the n-electrode region, followed by deposition (thermal or electron beam evaporation) of contact metals (e.g. AuGe/Au, 500 Å/1000 Å) that can adhere well to the n-layer of the EAM 10 (e.g. heavily doped InP layer) and form a relatively low resistivity ohmic contact (contact resistivity less than 10⁶ Ω-cm). After deposition, the masking materials are removed, leaving behind the metal contact region 83. The metals are annealed in an inert ambient of forming gas (5% hydrogen in 95% nitrogen) at around 280-300° C. to sinter the contact.

(v) Fabrication of electrodes of the transmission lines 85, 87 and the contact pad 84. This step is typically done using a lift-off technique in which mask openings (the lift-off mask can be commercially available photoresist and/or PMMA) are formed over the semi-insulating substrate 82, followed by deposition (thermal or electron beam evaporation) of metals (e.g. Ti/Au, 500 Å/5000 Å) that can adhere well to the substrate. After deposition, the masking materials are removed, leaving behind the metal strips 85, 87 and contact pad 89. In this step, the metal path 89 is also formed between the transmission line 87 to the p-electrode 86 of the EAM 10 over the dielectric film over the dielectric film 91.

(vi) Thinning of the substrate—At this point, the fabrication at the epilayer side of the substrate 82 is completed and the substrate is mounted topside down on a flat chuck for thinning. The thinning is performed in a polishing machine (e.g. a unit commercially-available from Logitech Product Group, Struers, Inc., Westlake, Ohio) using aluminum oxide grinding power until a predetermined thickness of the substrate (e.g. 100 μm) is reached. The thickness is determined by the consideration of the ground plane requirement of the microwave transmission lines and the ease of cleaving the substrate into separate chips.

(vii) Fabrication of transmission lines on the backside of the substrate 82. This step is typically performed by thermal deposition or electron beam evaporation of metals (e.g. Ti/Au, 500 Å/1500 Å) that can adhere well to the backside of the substrate for use as a ground plane 90.

### 5. Design Considerations for Microwave Resonant Circuit

The modulation depth of the EAM 10 depends on the electric field applied across the electroabsorption layer 14. However, when a microwave signal is applied to the modulator through a conventional 50Ω source, most of the microwave power is reflected due to the large mismatch between the modulator impedance (which is basically a capacitive load) and the source impedance. An approach to recover the capacitive loss is to use microwave impedance tuning. For cases where fractional transmission bandwidths are required, the impedance matching and resonant driving circuits are attractive approaches to enhance the drive efficiency.

Taking the lumped element representation of the modulator which is a capacitor, Cⱼ (junction capacitance) in parallel with a large junction resistance defined by the EAM 10, the microwave power coupled to the EAM from DC power supply 26 and VCU 30 is dissipated in the series resistance Rₛ of the EAM 10. Typically, the modulation voltage at the junction of the EAM 10 is proportional to the square root of the power coupled to the EAM, and is inversely proportional to the square root of the series resistance. The lower the Rₛ, and/or the higher the coupled power, the higher is the modulation voltage experienced across the junction of the EAM 10.

In typical impedance matching circuit, the microwave source, i.e., VCU 30 experiences a 50Ω load as opposed to a capacitive load, and thus the maximum transfer of microwave power from the source occurs. The voltage gain in this case is proportional to the square root of the source impedance divided by the series resistance Rₛ, provided that the insertion loss (that includes the conduction loss) of the impedance matching circuit is negligible.

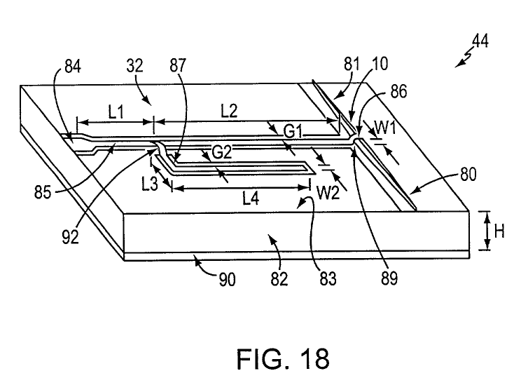

A “single shunt-stub tuner” with open termination is shown in FIGS. 17 and 18 for the simple impedance matcher. For example, the EAM 10 can have a capacitance Cⱼ of 0.5 pF, a series resistance Rₛ of 0.5Ω, and the IMC 32 can provide a voltage gain more than a factor of 2 at 10 GHz. Representative transmission line dimensions for the microstrip line version of the unit 44 are summarized in Table 1:

TABLE 1
Dimensions for Parameters of Impedance Matching Circuit

| | Dimension |
|---|---|
| Parameter | (microns) |
| L1 | 50 |
| L2 | 1400 |
| L3 + L4 | 1550 |
| W1 | 55 |
| W2 | 140 |
| H | 100 |

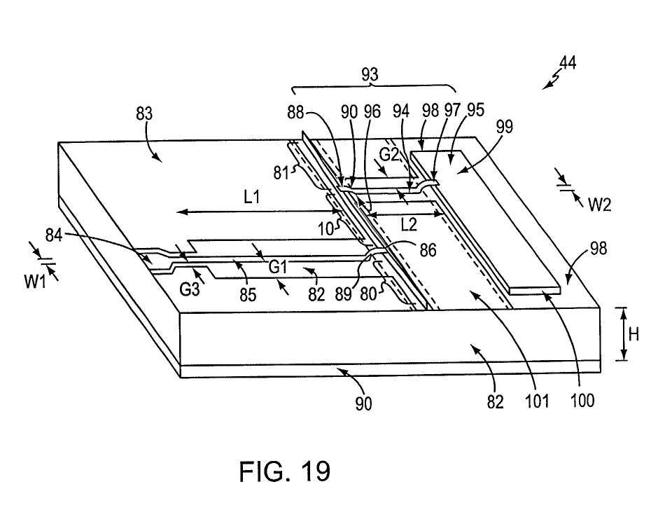

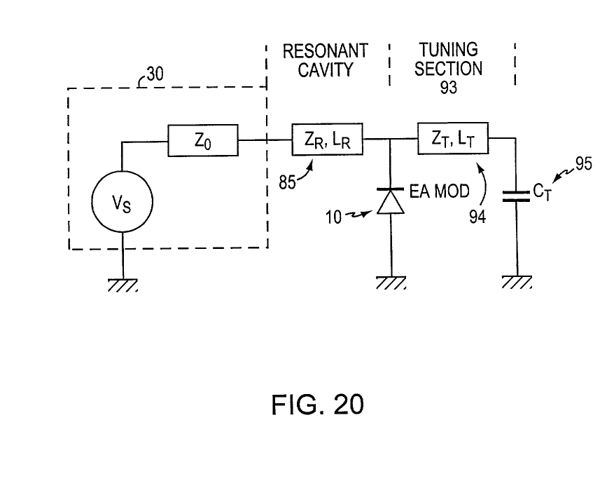

At higher frequencies at which the RC roll-off is relatively severe, comparatively high voltage gain is necessary to produce the same modulation depth as at lower frequencies. To enhance modulation depth at high frequencies, one can include a resonant tuning circuit to achieve an effective voltage gain, albeit at the expense of limiting the bandwidth since bandwidth is inversely proportional to the quality factor. An example of the resonant tuning circuit is shown in FIG. 19 FIG. 20 is a circuit diagram modeling the integrated unit 44 of FIG. 19. The clock source 26 and VCU 30 are modeled as a voltage source with an open-circuit voltage of V_{S} and an output impedance Z_{O}. The resonant cavity comprises the transmission line 85 modeled as an impedance Z_{R} and inductance L_{R} and the EAM 10. The tuning section 93 comprises the impedance Z_{T} and inductance L_{T} for the transmission line 94 in series with the capacitance C_{T} provided by the capacitor 95. The EAM 10 is coupled in reverse-bias between the resonant cavity and the tuning section 93. In FIG. 19, an LC tuning section 93 is formed on the substrate 90. The LC tuning section 93 comprises a relatively short transmission line 94 to provide inductance, and a capacitor 95 coupled to the transmission line 94. The transmission line 94 has one end coupled to the EAM 10 via conductive bridge 96, and its opposite end coupled to the capacitor 95 via conductive bridge 97. The capacitor 95 comprises a conductive plate 98 formed on the surface of the substrate 90, a dielectric 100, and a conductive plate 99 opposing the plate 98 and separated therefrom by the dielectric 100. The conductive plates 98, 99 can be composed of metal or metal alloy, and the dielectric 100 can be composed of SiO₂ or SiN formed through techniques previously mentioned. Plates 83 and 101 are formed on the surface of the substrate 90 spaced apart from respective transmission lines 85, 94 in the coplanar wave arrangement of FIG. 19. The LC tuning section 93 is electrically in parallel with the EAM 10. The shunting capacitor 95 at the end of the transmission line 94 functions as a DC block for the bias voltage V_{DC} applied to the EAM 10 and a short at RF/microwave frequency to the ground to provide tuning capability. The transmission line 85 provides a relatively short length of impedance Z_{R} in front of the tuned resonator to further enhance the quality factor.

### 6. Design Considerations for the Electro-Absorption Modulator (EAM) 10

The most important design considerations for the EAM 10 for its on-off operation are the drive voltage to achieve a certain extinction ratio, and the modulation bandwidth. There are two electrode designs for the EA modulator, the lumped electrode design and the traveling wave electrode design. The modulation response of the lumped-element EAM 10 is limited by its junction capacitance. The modulation bandwidth is quantitatively described by the 3-dB frequency, ƒ_{3dB}, which is inversely proportional to the device junction capacitance, Cⱼ. The device junction capacitance is proportional to the junction area and inversely proportional to intrinsic layer thickness, t. For the etched waveguide structure shown in FIGS. 19, 21A, 21B, the junction area A is determined by the width w and length L of p-type region 12. Therefore the capacitance is given by:

$${C}_{j} = \frac{ϵ A}{t} , \qquad ( 1 )$$

where A is the junction area, given by A=wL, ε is the dielectric constant and t is the thickness of the intrinsic layer 14. The intrinsic layer 14 comprises the electro-absorption (EA) layer. The EA layer 14 can be located within the top region of the lower mesa or the bottom region of the upper mesa. FIGS. 21A and 21B show the latter configuration.

The optical transmission of the EAM 10 can be characterized by an exponential function of form e^{-Γf}, where Γ is the optical confinement of the guided optical mode in the EAM 10, ƒ is the product of the absorption change Δα and the length L of EA waveguide section. Δα depends mainly on the (a) detuning energy between the electroabsorption edge and the photon energy (i.e., the difference between the bandgap energy of the layer 14 and the energy of the light of the optical signal transmitted through the layer 14); (b) the electric field at the electroabsorption layer 14, which is equal to the voltage across the layer 14 divided by the thickness of the EA layer 14. These criteria reveal trade-offs between the modulation bandwidth and the drive voltage. Both criteria depend on the length L of the EA waveguide section. The Γ factor is also a function of w and t and increases with increase in these parameters. These two criteria are thus interrelated. To achieve low drive voltage and high modulation bandwidth, a typical value of w lies in the range of 1.5-1.3 μm, while that of t is in the range of 0.2-0.35 μm, and that of L is in the range of 150-300 μm range.

There are two kinds of material effects that can give rise to a Δα for effective electroabsorption: the Franz-Keldysh effect in bulk semiconductor materials, and quantum confined Stark effect in multiple quantum well semiconductor materials. The later effect is described as it has a larger Δα. Quantum wells consist of a narrow well region surrounded by two barriers with higher bandgap energy. Electrons in the conduction band are confined in the well whose width is close to the deBroglie wavelength (˜100 Å) of electrons, so that as a group these electrons have a strong affinity to the group of holes in the valence band. This affinity is termed oscillation strength of the exciton, and it is a function of wavelength and electric field. The electroabsorption effect is manifested as the shift of the absorption edge and absorption coefficient as a function of the electric field and the wavelength of operation. The electroabsorption effect also gives rise to the detuning energy dependence previously mentioned. For too small a detuning energy (i.e. the photon energy is close to the absorption peak at zero bias), the quantum well suffers a large residual optical absorption due to near bandedge absorption at zero bias. Conversely, at too large a detuning energy, the resultant Δα is too small and a longer electrode L is needed to satisfy the small drive voltage requirement. For the modulation of optical light in the 1.55 μm wavelength region, for instance, one can employ multiple quantum well in the EA layer 14 that comprises alloyed InGaAsP semiconductor material (and barrier layer) with appropriate bandgap and thickness. Alternatively, one can use an InAlGaAs material system. Both can be designed to give absorption edge suitable for the 1.55 μm wavelength region.

FIG. 21A is a cross-section of the EAM 10 having an active layer 14 with multiple quantum wells. The EAM 10 is formed on the substrate 82. The n-type semiconductor region 16 is disposed on the substrate 82. The n-type region 16 can be composed of n-doped InP or GaAs, for example. The active region 14 can be composed of alternating layers of undoped InGaAsP and undoped InP. Alternatively, the active region 14 can be composed of one or more layers of GaAs positioned between layers of AlGaAs and AlGaAs. Typical dimensions of these layers can be from one (1) to five (5) nanometers in thickness. From five (5) to fifteen (15) of such alternating layers can be used in the active region 14. The p-type and n-type semiconductor regions 12, 16 are disposed in contact with the active region 14 on opposite sides thereof. The regions 12, 16 have a lower refractive index than the active region 14 and thus, as positioned on opposite sides of the active region 14, tend to confine light within the active region to prevent its loss. The p-type and n-type regions 12, 16 can be composed of one or more layers of p-doped and n-doped InGaAsP layers respectively in the case of InP/InGaAsP, or one or more layers of n-AlGaAs and p-AlGaAs in the case of the GaAs/AlGaAs. The n-type region 16 can have an etch stop layer 105 composed of InP or GaAs formed over the upper surface of the n-type region 16 to provide a barrier layer to prevent etching of the n-type region in patterning the p-type and active regions 12, 14. The dielectric film 91 composed of SiO₂ or SiN defines side walls of the EAM 10 and are disposed in contact with the active region 14. The dielectric film 91 also insulates the active region 14 from the conductive bridge 89 that provides electrical connection between the p-type region 12 and the transmission line 85 of the IMC 32.

FIG. 21B is a cross-section of the EAM 10 in which the active region 14 is composed of bulk semiconductor material such as undoped InGaAsP and undoped InP, situated in contact with and between regions 12, 16 composed of one or more layers p-doped and n-doped InP or GaAs, respectively. In other respects, EAM 10 of FIG. 21B is similar to that of FIG. 21A.

### 7. Design and Configuration of Spot-Size Converters (SSCs) 80, 81

There are two major coupling losses between an optical fiber (not shown) and a semiconductor waveguide, namely, the Fresnel refraction loss and the spot-size mismatch loss. The refractive index of the core of an optical fiber is approximately 1.5 while that of semiconductor material is greater than 3.2. Typically, the Fresnel refraction loss is minimized by using a refractive-index-matching (anti-reflection) layer composed of a relatively thin film of SiO₂, SiN, or other material at the facet between the semiconductor material and optical fiber. Another important issue is the spot size mismatch between the semiconductor device and the fiber. One approach to this issue is to enlarge the spot size of the waveguide in active section. However, this necessarily impacts and can compromise the semiconductor device performance. A more attractive approach is to transform the mode from that close to fiber mode (which is axially symmetric) to one that is tightly confined around the active layer of the device to channel light to the device, and vice versa, to couple light from the device to an output fiber.

The main function for the spot-size conversion waveguide 80 is to transform, with very little added loss, the optical mode from a large size spot size at the front end to a tightly confined mode around the electroabsorption region 14 in the EAM 10. The spot-size converter 81 operates in the converse manner to convert light from the tightly confined spot size to a comparatively large spot size that couples efficiently to a cleaved or lensed fiber.

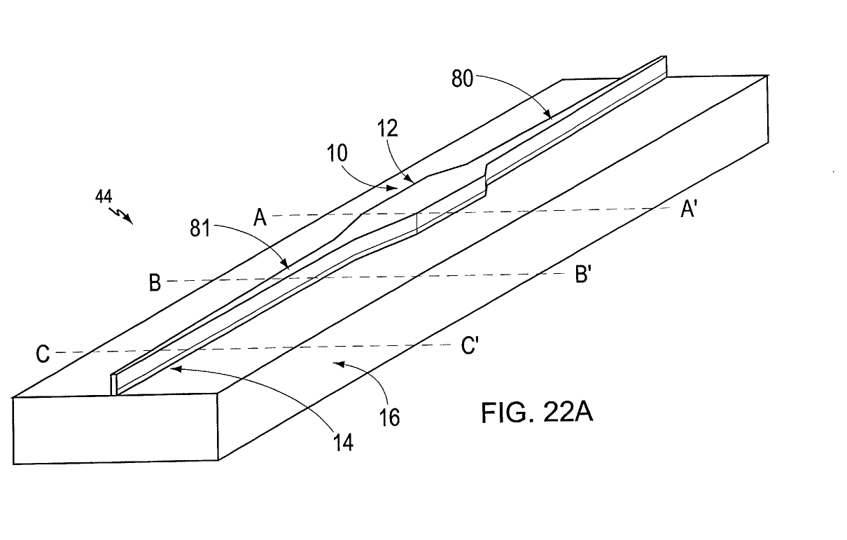

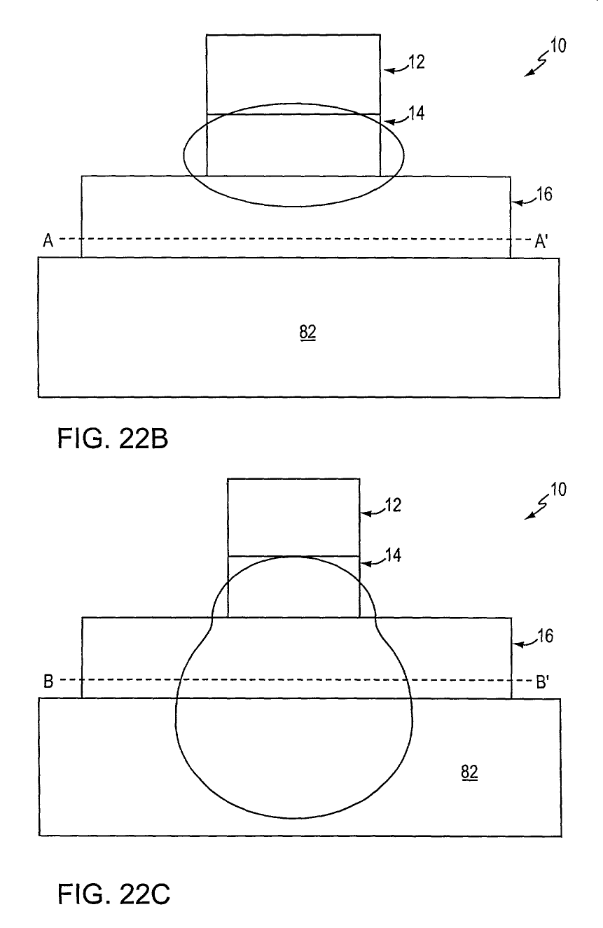

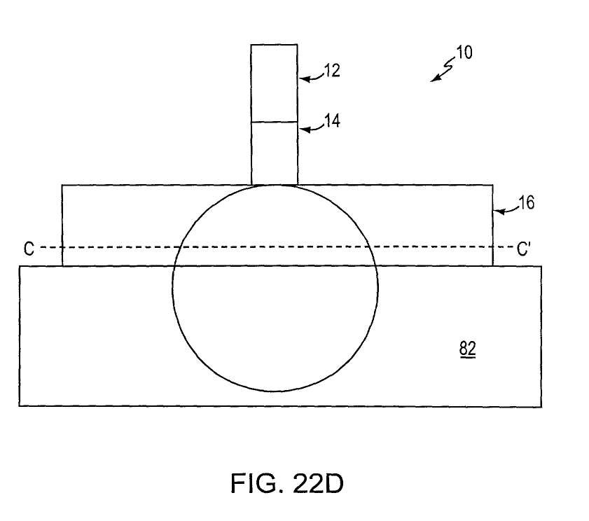

FIG. 22A is a perspective view of the integrated unit 44 incorporating the EAM 10 and spot-size converters 80, 81. Reference axes A-A′, B-B′, and C-C′ are shown at different positions along the EAM 10 and spot-size converters 80. At the input end of the converter 80, the width of the upper mesa is narrow and the effective refractive index of the mesa is low enough that the fundamental mode of propagating light is confined in the lower mesa. Typically, the input and output waveguide width is ˜8-9 μm for efficient coupling to an optical fiber. At the other end of the converter near the EAM 10, the upper mesa is wide enough that the fundamental mode is confined near the bottom of the upper mesa where the electroabsorption region 14 is positioned.

To ensure a relatively low loss transfer of optical energy from one waveguide to another, there are two requirements. The transfer has to be adiabatic with the index change and mode profile change gradually along the waveguide. The dominant modes at both ends are the fundamental mode. This can be achieved by gradually changing the waveguide width, as in a taper. The longer the taper, the more complete is the transform. However, the maximum length of the tapered waveguide is constrained by the residual absorption in the waveguide material and typically less than a few hundred micrometers is desirable. This can be achieved by more aggressive taper in which the tapered waveguide has regions of different tapering rate. Typically, for the 2-3 μm upper mesa width at the EA waveguide section, two to three subsections of different tapering rate are used in the converter section for efficient transfer.

Exemplary profiles of the spot-size of an optical signal traveling from the EAM 10 through the converter 81 are indicated in the cross-sectional views of FIGS. 22B-22D taken along respective axes A-A′, B-B′, C-C′ of FIG. 22A. As shown in FIG. 22B, the optical signal is relatively confined to the active region 14 as it travels in the EAM 10 at axis A-A′. However, as the optical signal propagates in the converter 81, energy of the optical signal moves from the active region 14 to the n-type region 16 as the width of the converter 81 narrows, as shown in FIG. 22C for the B-B′ axis. In FIG. 22D at axis C-C′, the energy of the optical signal propagates primarily in the n-type region 16 because the width of the active region 14 is relatively narrow at the output end of the converter 81. The spot-size of the optical signal in the n-type region 16 is relatively large and can be coupled more readily to an optical fiber as a result of its large size.

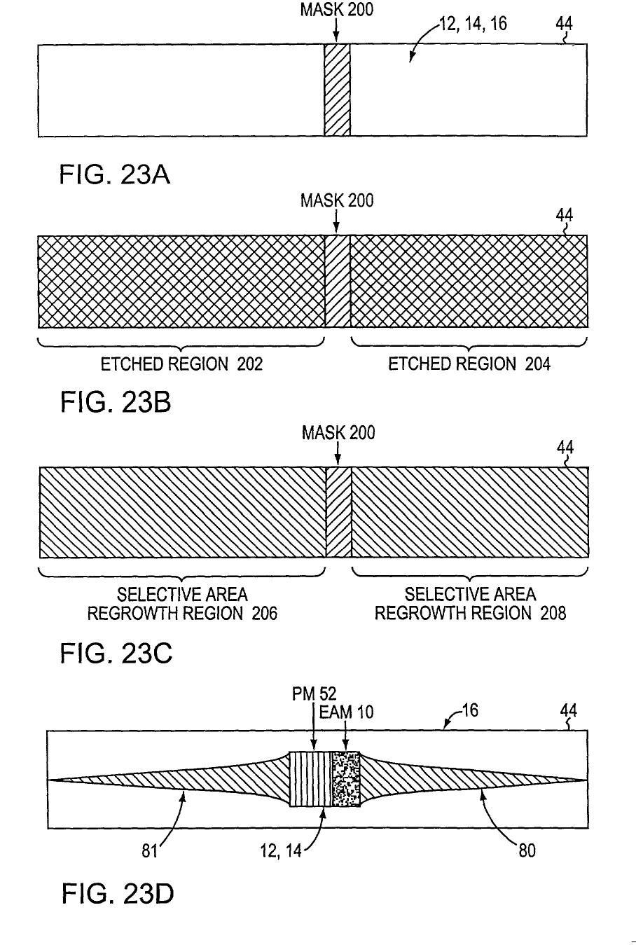

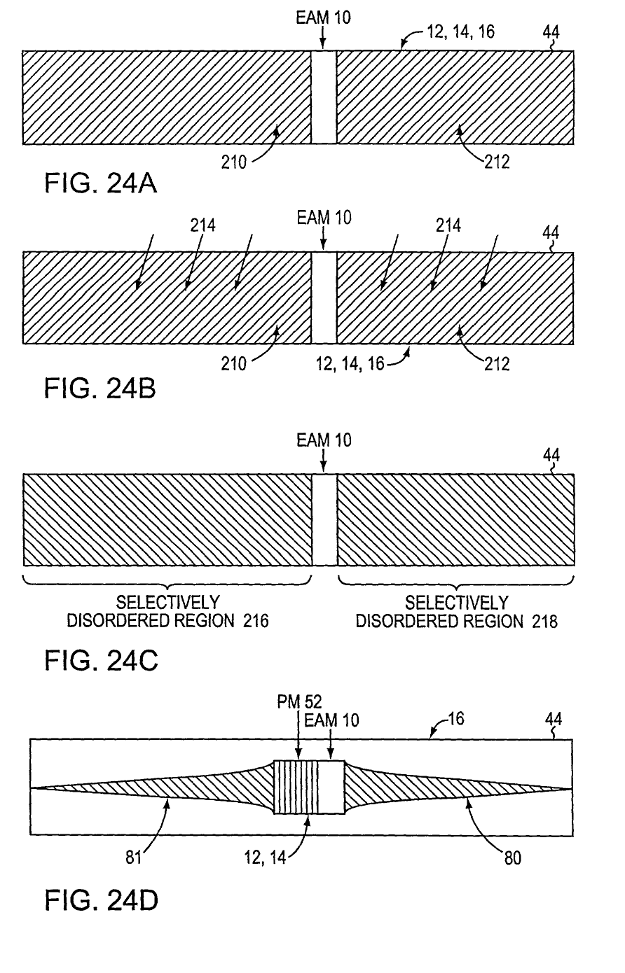

To ensure a low propagation loss in the converters 80, 81, the epilayers of such converters should not be absorbing at the wavelength of the optical light propagating therein. However, if the same material structure for the EAM 10 is used in the mode converters 80, 81, the residual absorption in the mode converter waveguide can be relatively large. This absorption loss can be minimized by epitaxial regrowth (FIGS. 23A-23D) in which the absorbing layer is selectively removed and replaced with material that is not absorbing at the incident wavelength using either metal-organic chemical vapor deposition system or gas-source molecular beam epitaxy reactor. Alternatively, one can use selective superlattice disordering technique (FIGS. 24A-24D) through which the intermixing in the quantum well in the converter regions 80, 81 results in a relatively high bandgap material that is comparatively transparent to the optical signal to be modulated by the EAM 10.

Referring to FIGS. 23A-23D, the method of epitaxial regrowth to form the converters 80, 81 is now described. The method starts with a substrate 82 upon which regions 12, 14, 16 have been formed. A mask 200 is formed over the layer 16 and patterned by selective exposure with a photolithography or e-beam system, is developed and baked to harden the resist. In FIG. 23B the regions 202, 204 on either side of the mask 200 are etched with a suitable etching techniques such as reactive ion etching (RIE) to remove regions 12, 14 and expose the region 16. In FIG. 23C material having a larger bandgap than the energy of light of the optical signal to be used with the unit 44 is formed on the n-type region 16 as selective area regrowth region 206, 208. For example, for an optical signal with light at 1.55 μm, regrown regions of InGaAsP can be formed on the n-type region 16 with a quaternary composition yielding a bandgap energy of 1.4 μm as compared to a bandgap of 1.48 μm of the EAM 10 underlying the mask 200. P-type region 12 in the case of phase modulator or undoped region in the case of the SSC can be regrown on the regions 206, 208. In FIG. 23D the mask 200 is removed from the substrate and the layers 12, 14 are patterned using other masks and photolithography or e-beam lithography to form the EAM 10 and the converters 80, 81. The material composing the regrown areas can be suitable for formation of one or more other devices such as the PM 52 formed adjacent the EAM 10. Hence an optical signal supplied via the converter 80 can be modulated with the EAM 10 and chirp-compensated with the PM 52. The resulting optical signal can be output via the converter 81 to a downstream element.

In FIGS. 24A-24D, a selective disordering method for use with the integrated unit 44 is now described. In FIG. 24A vacancy-inducing films 210, 212 are formed over the regions 12, 14, 16 of the integrated unit 44. The films can be composed of SiO₂ in a thickness of 0.2 μm or more. In FIG. 24B the integrated unit 44 is subjected to rapid thermal annealing (RTA) represented by arrows 214 at 500-1000° Celsius for ten (10) seconds to five (5) minutes in a suitable oven. In FIG. 24C the films 210, 212 are removed from the selectively disordered regions 216, 218. In FIG. 24D the EAM 10, PM 52 and spot-size converters 80, 81 are patterned using standard photolithography or e-beam lithography techniques. Because randomization of the structure of the active region 14 in the disordered regions 216, 218 increases their bandgap energy, devices such as the PM 52 and the spot-size converters 80, 18 can be formed without undue absorption of the optical signal propagating through such devices.

In situations in which tight control on the exact placement of the vacancies is desired or required, an alternative selective disordering method can be used to implement the integration scheme. First the sample is covered with a layer of photoresist. Windows are photolithographically defined in the photoresist and removed using a developer solution. Silicon ions or phosphorus ions are implanted through the windows and the remaining photoresist is removed using a solvent such as acetone. The sample is then annealed at temperatures ranging from 500° to 800° Celsius for ten (10) seconds to five (5) minutes in a suitable oven. The EAM, PM and spot-size converters are patterned using standard photolithography or e-beam lithography techniques. The advantage of using this technique is that a precise control on the dosage of the ion implant gives rise to a very accurate degree of disordering obtained. Generally the anneal takes place at slightly lower temperatures.

Another issue regarding the converters 80, 81 is the electrical isolation between such converters and the EAM 10. Due to their relatively long length, generally about three to five times that of the EAM 10 or greater, the added capacitance of the converters can reduce the modulation bandwidth of the EAM 10. Such capacitance can be reduced by removing the p-type region 12 where it overlies the converters 80, 81. For example, this can be accomplished by regrowth of an n-type layer over the upper mesa, by removing a short section of the p-type region 12 connecting the converters 80, 81 and the EAM 10, or by creating a relatively high resistive region between the converters 80, 81 and the EAM 10 via ion-implantation using a proton or helium implant.

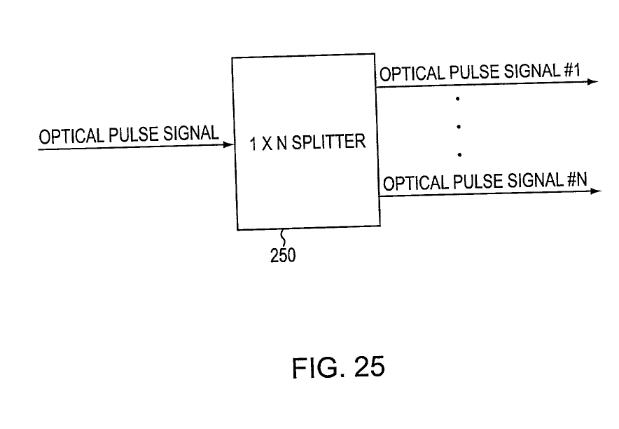

FIG. 25 is a schematic diagram of a 1×N splitter 250, N being any positive integer. Such splitter 250 can be coupled to the output of any of the apparatuses shown in the Figures, either as a discrete device or as an integrated component of the unit 44. The 1×N splitter 250 splits the optical signal into two or more output signals as is well-known in the optical networking industry.

In the foregoing Figures and description, numerous of the elements are indicated as formed in the integrated unit 44. Such elements can alternatively be formed as discrete units without departing from the scope of the invention.

The many features and advantages of the present invention are apparent from the detailed specification and thus, it is intended by the appended claims to cover all such features and advantages of the described apparatus and methods which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling within the spirit and scope of the invention.

1. An apparatus receiving continuous wave (CW) laser light, the apparatus comprising:
a DC power supply generating a DC voltage;
a voltage control unit (VCU) generating an AC voltage;
a controller coupled to the DC power supply and VCU, the controller generating at least one control signal to control respective magnitudes of the DC and AC voltages; and
an electro-absorption modulator (EAM) coupled to receive the CW laser light and the DC and AC voltages from the DC power supply and VCU, the EAM modulating the CW light based on the DC and AC voltages applied to the EAM to produce an optical signal having a duty cycle defined by the magnitudes of the DC and AC voltages and a frequency defined by the frequency of the AC voltage.

2. An apparatus as claimed in claim 1 further comprising:
a DC power supply coupled to receive the control signal from the controller, and generating the DC voltage based on the received control signal.

3. An apparatus as claimed in claim 1 further comprising:
a voltage control unit (VCU) coupled to receive the control signal from the controller, and generating the AC voltage based on the received control signal.

4. An apparatus as claimed in claim 1 wherein the EAM has an active region with a multiple quantum well structure.

5. An apparatus as claimed in claim 1 wherein the EAM is composed of bulk semiconductor material.

6. An apparatus as claimed in claim 1 further comprising:
a CW source coupled to the EAM, the CW source generating the CW laser light supplied to the EAM.

7. An apparatus as claimed in claim 1 further comprising:
a spot-size converter coupled to supply the CW laser light to the EAM.

8. An apparatus as claimed in claim 7 wherein the spot-size converter and EAM are formed on an integrated unit.

9. An apparatus as claimed in claim 7 wherein the spot-size converter is formed by selective area regrowth.

10. An apparatus as claimed in claim 7 wherein the spot-size converter is formed by selective area disordering.

11. An apparatus as claimed in claim 1 wherein the apparatus is coupled to a downstream element, the apparatus further comprising:
a spot-size converter coupled to supply the optical signal from the EAM to the downstream element.

12. An apparatus as claimed in claim 11 wherein the spot-size converter and EAM are formed on an integrated unit.

13. An apparatus as claimed in claim 11 wherein the spot-size converter formed by selective area regrowth.

14. An apparatus as claimed in claim 11 wherein the spot-size converter is formed by selective area disordering.

15. An apparatus as claimed in claim 1 further comprising:
an impedance matching circuit (IMC) coupled to receive the DC and AC voltages, and coupled to supply the DC and AC voltages to the EAM.

16. An apparatus as claimed in claim 15 wherein the IMC is integrated with the EAM in an integrated unit.

17. An apparatus receiving continuous wave (CW) laser light, the apparatus comprising:
a first DC power supply generating a DC voltage;
a first voltage control unit (VCU) generating an AC voltage;
a delay unit generating a delayed clock signal;
a second DC power supply generating a DC voltage;
a second VCU generating an AC voltage;
a controller coupled to the first DC power supply, the first VCU, the second DC power supply, and the second VCU, the controller generating at least one control signal to control respective magnitudes of the DC and AC voltages of the first DC power supply the first VCU, and generating at least one control signal to control the second DC power supply and the second VCU;
an electro-absorption modulator (EAM) coupled to receive the CW laser light and the DC and AC voltages from the first DC power supply and first VCU, the EAM modulating the CW light based on the DC and AC voltages applied to the EAM to produce an optical signal having a duty cycle defined by the magnitudes of the DC and AC voltages and a frequency defined by the frequency of the AC voltage; and
a phase modulator (PM) coupled to receive the second DC and AC voltages and the delay clock signal, and coupled to receive the optical signal from the EAM, the PM chirp-compensating the optical signal based on the second DC and AC voltages and the delayed clock signal to produce a chirp-compensated optical signal.

18. An apparatus as claimed in claim 17 wherein the PM has an active region composed of a multiple quantum well structure.

19. An apparatus as claimed in claim 17 wherein the PM has an active region composed of a bulk semiconductor material.

20. An apparatus as claimed in claim 17 wherein the EAM and the PM are integrated together in an integrated unit.

21. An apparatus as claimed in claim 20 wherein the PM is formed by selective area regrowth.

22. An apparatus as claimed in claim 20 wherein the PM is formed by selective area disordering.

23. An apparatus as claimed in claim 17 further comprising:
an impedance matching circuit (IMC) coupled to receive the second DC and AC voltages from the second DC power supply and the second VCU, and coupled to supply the second DC and AC voltages to the PM.

24. An apparatus as claimed in claim 23 wherein the IMC is integrated with the PM on an integrated unit.

25. An apparatus as claimed in claim 17 further comprising:
a clock source generating a clock signal, the clock source coupled to supply the clock signal to the delay unit, the delay unit generating the delayed clock signal based on the clock signal from the clock source.

26. An apparatus as claimed in 17 wherein the PM is coupled to a downstream element, the apparatus further comprising:
a spot-size converter coupled to receive the chirp-compensated optical signal from the PM, the spot-size converter coupling the chirp-compensated optical signal to the downstream element.

27. An apparatus as claimed in claim 26 wherein the spot-size converter is formed by selective area regrowth.

28. An apparatus as claimed in claim 26 wherein the spot-size converter is formed by selective area disordering.

29. An apparatus as claimed in 17 wherein the EAM is coupled to receive the CW laser light from an upstream element, the apparatus further comprising:
a spot-size converter coupled to receive the chirp-compensated optical signal from the EAM, the spot-size converter coupling the chirp-compensated optical signal to the downstream element.

30. An apparatus as claimed in claim 29 wherein the spot-size converter is formed by selective area regrowth.

31. An apparatus as claimed in claim 29 wherein the spot-size converter is formed by selective area disordering.

32. An apparatus receiving continuous wave (CW) laser light, the apparatus comprising:
a first DC power supply generating a DC voltage;
a first voltage control unit (VCU) generating an AC voltage;
a delay unit generating a delayed clock signal;
a second DC power supply generating a DC voltage;
a second VCU generating an AC voltage;
a controller coupled to the first DC power supply, the first VCU, the second DC power supply, and the second VCU, the controller generating at least one control signal to control respective magnitudes of the first DC and AC voltages of the first DC power supply the first VCU, respectively, and generating at least one control signal to control the second DC and AC voltages of the DC power supply and the second VCU, respectively;
a phase modulator (PM) coupled to receive the second DC and AC voltages, and coupled to receive the CW light, the PM phase modulating the CW light to produce frequency chirp based on the additional DC and AC voltages; and
an electro-absorption modulator (EAM) coupled to receive the chirp-compensated CW laser light and the first DC and AC voltages, the EAM modulating the CW light based on the first DC and AC voltages applied to the EAM to produce an optical signal having a duty cycle defined by the magnitudes of the first DC and AC voltages and a frequency defined by the frequency of the first AC voltage.

33. An apparatus as claimed in claim 32 further comprising:
a spot-size converter coupled to receive the CW laser light, and coupled to supply the CW laser light to the PM.

34. An apparatus as claimed in claim 33 wherein the IMC is formed together with the PM as an integrated unit.

35. An apparatus as claimed in claim 33 wherein the spot-size converter is formed by selective area regrowth.

36. An apparatus as claimed in claim 33 wherein the spot-size converter is formed by selective area disordering.

37. An apparatus as claimed in claim 32 wherein the EAM is coupled to a downstream element, the apparatus further comprising:
a spot-size converter coupled to receive the optical signal from the EAM.

38. An apparatus as claimed in claim 37 wherein the IMC is formed together with the EAM as an integrated unit.

39. An apparatus as claimed in claim 37 wherein the spot-size converter is formed by selective area regrowth.

40. An apparatus as claimed in claim 37 wherein the spot-size converter is formed by selective area disordering.

41. An apparatus as claimed in claim 32 further comprising:
a impedance matching circuit (IMC) coupled to receive the second DC and AC voltages from the second power supply and second VCU, respectively, and coupled to supply the second DC and AC voltages to the PM.

42. An apparatus as claimed in claim 16 wherein the EAM is a part of a resonant circuit.

43. An apparatus as claimed in claim 42 wherein the resonant circuit is resonant at the frequency of the AC voltage.

44. An apparatus as claimed in claim 23 wherein the PM is a part of a resonant circuit.

45. An apparatus as claimed in claim 44 wherein the resonant circuit is resonant at the frequency of the additional AC voltage.

46. An apparatus as claimed in claim 44 wherein the PM is a part of a resonant circuit.

47. An apparatus as claimed in claim 44 wherein the resonant circuit is resonant at the frequency of the additional voltage.

48. An apparatus as claimed in 1 wherein the apparatus receives data, the apparatus further comprising:
a non-return-to-zero (NRZ) modulator coupled to receive the data and the optical signal from the EAM, the NRZ modulator modulating the optical signal based on the data to generate a return-to-zero (RZ) optical data signal.

49. An apparatus as claimed in claim 48 wherein the NRZ modulator is electro-absorptive.

50. An apparatus as claimed in claim 48 wherein the NRZ modulator is electro-refractive.

51. An apparatus as claimed in claim 48 wherein the NRZ modulator is formed as an integrated unit.

52. An apparatus as claimed in claim 48 wherein the NRZ modulator is formed by selective area regrowth.

53. An apparatus as claimed in claim 48 wherein the NRZ modulator is formed by selective area disordering.

54. An apparatus as claimed in claim 17 wherein the apparatus receives data, the apparatus further comprising:
a non-return-to-zero (NRZ) modulator coupled to receive the data and the chirp-compensated optical signal from the PM, the NRZ modulator modulating the chirp-compensated optical signal based on the data to generate a return-to-zero (RZ) optical data signal.

55. An apparatus as claimed in claim 54 wherein the NRZ modulator is electro-absorptive.

56. An apparatus as claimed in claim 54 wherein the NRZ modulator is electro-refractive.

57. An apparatus as claimed in claim 54 wherein the NRZ modulator is formed as an integrated unit.

58. An apparatus as claimed in claim 57 wherein the NRZ modulator is formed by selective area regrowth.

59. An apparatus as claimed in claim 57 wherein the NRZ modulator is formed by selective area disordering.

60. An apparatus as claimed in claim 32 wherein the apparatus receives data, the apparatus further comprising:
a non-return-to-zero (NRZ) modulator coupled to receive the data and the optical signal from the EAM, the NRZ modulator modulating the optical signal based on the data to generate a return-to-zero (RZ) optical data signal.

61. An apparatus as claimed in claim 60 wherein the NRZ modulator is electro-absorptive.

62. An apparatus as claimed in claim 60 wherein the NRZ modulator is electro-refractive.

63. An apparatus as claimed in claim 60 wherein the NRZ modulator is formed as an integrated unit.

64. An apparatus as claimed in claim 60 wherein the NRZ modulator is formed by selective area regrowth.

65. An apparatus as claimed in claim 60 wherein the NRZ modulator is formed by selective area disordering.

66. An apparatus as claimed in claim 17 wherein the AC voltage supplied to the EAM is non-return-to-zero (NRZ) data, and the AC voltage supplied to the PM is a clock signal.

67. An apparatus as claimed in claim 32 wherein the AC voltage supplied to the EAM is non-return-to-zero data, and the AC voltage supplied to the PM is a clock signal.

68. An apparatus as claimed in claim 17 wherein the AC voltages supplied to the EAM and PM are NRZ data.

69. An apparatus as claimed in claim 32 wherein the AC voltages supplied to the EAM and PM are NRZ data.

70. An apparatus as claimed in claim 1 further comprising:
a 1×N splitter coupled to receive the optical signal from the EAM, and splitting the optical signal into a plurality of optical signals.

71. An apparatus as claimed in claim 70 wherein the 1×N splitter is formed as an integrated unit.

72. An apparatus as claimed in claim 70 wherein the 1×N splitter is formed by selective area regrowth.

73. An apparatus as claimed in claim 70 wherein the 1×N splitter is formed by selective area disordering.

74. An apparatus as claimed in claim 17 further comprising:
a 1×N splitter coupled to receive the optical signal from the PM, and splitting the optical signal into a plurality of optical signals.

75. An apparatus as claimed in claim 74 wherein the 1×N splitter is formed as an integrated unit.

76. An apparatus as claimed in claim 74 wherein the 1×N splitter is formed by selective area regrowth.

77. An apparatus as claimed in claim 74 wherein the 1×N splitter is formed by selective area disordering.

78. An apparatus as claimed in claim 32 further comprising:
a 1×N splitter coupled to receive the optical signal from the EAM, and splitting the optical signal into a plurality of optical signals.

79. An apparatus as claimed in claim 78 wherein the 1×N splitter is formed as an integrated unit.

80. An apparatus as claimed in claim 78 wherein the 1×N splitter is formed by selective area regrowth.

81. An apparatus as claimed in claim 78 wherein the 1×N splitter is formed by selective area disordering.

82. An apparatus as claimed in claim 48 further comprising:
a 1×N splitter coupled to receive the optical signal from the NRZ modulator, and splitting the optical signal into a plurality of optical signals.

83. An apparatus as claimed in claim 82 wherein the 1×N splitter is formed as an integrated unit.

84. An apparatus as claimed in claim 82 wherein the 1×N splitter is formed by selective area regrowth.

85. An apparatus as claimed in claim 82 wherein the 1×N splitter is formed by selective area disordering.

86. An apparatus as claimed in claim 54 further comprising:
a 1×N splitter coupled to receive the optical signal from the NRZ modulator, and splitting the optical signal into a plurality of optical signals.

87. An apparatus as claimed in claim 86 wherein the 1×N splitter is formed as an integrated unit.

88. An apparatus as claimed in claim 86 wherein the 1×N splitter is formed by selective area regrowth.

89. An apparatus as claimed in claim 86 wherein the 1×N splitter is formed by selective area disordering.

90. An apparatus as claimed in claim 60 further comprising:
a 1×N splitter coupled to receive the optical signal from the NRZ modulator, and splitting the optical signal into a plurality of optical signals.

91. An apparatus as claimed in claim 90 wherein the 1×N splitter is formed as an integrated unit.

92. An apparatus as claimed in claim 90 wherein the 1×N splitter is formed by selective area regrowth.

93. An apparatus as claimed in claim 90 wherein the 1×N splitter is formed by selective area disordering.

94. An apparatus receiving continuous wave (CW) laser light, the apparatus comprising:
an electro-absorption modulator (EAM) coupled to receive the CW laser light, the EAM for modulating the CW laser light propagating therethrough; and
a phase modulator (PM) coupled to the EAM, for providing chirp compensation of the CW laser light propagating through the EAM and the PM, the EAM and the PM integrated together as an integrated unit.

95. An apparatus as claimed in claim 94 wherein at least one of the EAM and the PM have an active region with a multiple quantum well structure.

96. An apparatus as claimed in claim 94 wherein at least one of the EAM and the PM have an active region composed of bulk semiconductor material.

97. An apparatus as claimed in claim 94 wherein the PM is formed by selective area regrowth.

98. An apparatus as claimed in claim 94 wherein the PM is formed by selective area disordering.

99. An apparatus as claimed in claim 97 further comprising:
an impedance matching circuit (IMC) coupled to the EAM and formed as part of the integrated unit.

100. An apparatus as claimed in claim 97 further comprising:
an impedance matching circuit (IMC) coupled to the PM and formed as part of the integrated unit.

101. An apparatus as claimed in claim 94 further comprising:
a spot-size converter coupled to receive and supply CW laser light to the EAM and PM, the spot-size converter formed as part of the integrated unit.

102. An apparatus as claimed in claim 94 further comprising:
a spot-size converter coupled to receive and output an optical signal based on the CW laser light from the EAM and PM, the spot-size converter formed as part of the integrated unit.

103. An apparatus as claimed in claim 94 further comprising:
an optical amplifier (OA) coupled to receive light based on the CW laser light from at least one of the EAM and PM, for amplifying the received light to increase and or regulate its average output power.

104. An apparatus as claimed in claim 94 wherein the apparatus receives data, the apparatus further comprising:
a non-return-to-zero (NRZ) data modulator coupled to receive light from at least one of the EAM and PM, the NRZ data modulator modulating the received light based on the data.

105. An apparatus comprising:
a controller generating control signals indicating DC and AC voltages;
a DC power supply coupled to receive the control signal indicating the DC voltage, and generating the DC voltage based thereon;
a clock source generating a clock signal;
a voltage control unit (VCU) coupled to receive the clock signal from the clock source, the VCU coupled to the controller to receive the signal indicating the AC voltage, and coupled to the clock source to receive the clock signal;
an impedance matching circuit (IMC) coupled to receive the DC and AC voltages; and
a continuous wave (CW) source generating CW laser light;
an electro-absorption modulator (EAM) coupled to receive the DC and AC voltages from the impedance matching circuit, and the CW laser light, and generating an optical signal having a duty cycle based on the DC and AC voltages.

106. An apparatus as claimed in claim 105 wherein the controller comprises:
a processor;
a memory storing a control program and data indicating the DC and AC voltages;
an input device for supplying the data indicating DC and AC voltages to the memory; and
an output device generating a display based on operation of the input device, the processor executing the control program to generate the control signals based on the data stored in the memory.

107. An apparatus as claimed in claim 105 wherein the controller generates a control signal indicating a frequency of the clock signal, the controller coupled to supply the control signal indicating the clock frequency to the clock source, the clock source generating the clock signal at the frequency based on the control signal from the controller.

108. An apparatus as claimed in claim 105 wherein the controller generates control signals indicating the delay time and additional DC and AC voltages, the apparatus further comprising:
a delay unit coupled to receive the clock signal from the clock source and the control signal indicating the delay time, and generating a delayed clock signal based thereon;
an additional DC power supply coupled to receive the control signal indicating the additional DC voltage from the controller, the additional DC power supply generating the DC voltage based thereon;
an additional VCU coupled to receive the control signal indicating the additional AC voltage from the controller, and generating the additional AC voltage signal based thereon;
a second IMC coupled to receive the additional AC and DC voltages; and
a phase modulator (PM) coupled to receive at least one of the CW light and the optical signal from the EAM, and the additional DC and AC voltages, the PM chirp-compensating at least one of the CW light and optical signal based on the additional DC and AC voltages.

109. An apparatus receiving data for modulation, the apparatus comprising:
a controller generating control signals indicating DC and AC voltages;
a first DC power supply coupled to receive the control signal indicating the DC voltage, and generating the DC voltage based thereon;
a clock source generating a clock signal;
a non-return-to-zero (NRZ) data modulator coupled to receive the data and the clock signal, the NRZ modulator generating an NRZ data signal based on the data and clock signal;
a voltage control unit (VCU) coupled to receive the NRZ data signal from the NRZ modulator and the signal indicating the AC voltage from the controller, and generating the AC voltage signal based on the NRZ data signal and the AC voltage;
an impedance matching circuit coupled to receive the DC and AC voltages;
a continuous wave (CW) source generating CW laser light; and
an electro-absorption modulator (EAM) coupled to receive the DC and AC voltages from the impedance matching circuit, and the CW laser light, and generating an optical signal having a duty cycle based on the DC and AC voltages.

110. An apparatus as claimed in claim 100 wherein the controller generates control signals indicating the delay time and additional DC and AC voltages, the apparatus further comprising:
a delay unit coupled to receive the clock signal from the clock source and the control signal indicating the delay time, and generating a delayed clock signal based thereon;
an additional DC power supply coupled to receive the control signal indicating the additional DC voltage from the controller, the additional DC power supply generating the additional DC voltage based thereon;
an additional VCU coupled to receive the delayed clock signal and the control signal indicating the additional AC voltage from the controller, and generating the additional AC voltage signal based thereon;
a second IMC coupled to receive the additional AC and DC voltages; and
a phase modulator (PM) coupled to receive at least one of the CW light and the optical signal from the EAM, and the additional DC and AC voltages, the PM chirp-compensating at least one of the CW light and optical signal based on the additional DC and AC voltages.

111. An apparatus as claimed in claim 100 wherein the controller generates control signals indicating the delay time and additional DC and AC voltages, the apparatus further comprising:
a delay unit coupled to receive the NRZ data signal from the NRZ data modulator and the control signal indicating the delay time, and generating a delayed NRZ data signal based thereon;
an additional DC power supply coupled to receive the control signal indicating the additional DC voltage from the controller, the additional DC power supply generating the additional DC voltage based thereon;
an additional VCU coupled to receive the delayed NRZ data signal and the control signal indicating the additional AC voltage from the controller, and generating the additional AC voltage signal based thereon;
a second IMC coupled to receive the additional AC and DC voltages; and
a phase modulator (PM) coupled to receive at least one of the CW light and the optical signal from the EAM, and the additional DC and AC voltages, the PM chirp-compensating at least one of the CW light and optical signal based on the additional DC and AC voltages.

112. An apparatus as claimed in claim 111 wherein the controller generates a control signal indicating an optical amplification (OA) voltage, the apparatus further comprising:
an additional DC power supply coupled to receive the control signal indicating the OA voltage, and generating the OA voltage based thereon;
an additional IMC coupled to receive the OA voltage; and
an optical amplifier coupled to receive the OA voltage via the additional IMC, and the optical signal from the EAM, and generating an amplified optical signal based thereon.

113. An apparatus as claimed in claim 111 wherein the apparatus receives data for modulation, the apparatus further comprising:
a non-return-to-zero (NRZ) data modulator coupled to receive the data and the amplified optical signal from the optical amplifier, the NRZ data modulator generating an optical NRZ data signal based on the data and the amplified optical signal.

114. An apparatus as claimed in claim 111 wherein the apparatus receives data for modulation, the apparatus further comprising:
a non-return-to-zero (NRZ) data modulator coupled to receive the data and the optical signal from the EAM, the NRZ data modulator generating an optical NRZ data signal based on the data and the optical signal.

115. A method comprising the step of:
a) generating a variable duty cycle return-to-zero (RZ) optical pulse signal.

116. A method as claimed in claim 115 wherein the step (a) is performed by an electro-absorption modulator (EAM), the method further comprising:
b) controlling DC and AC voltages applied to the EAM to variably control the duty cycle of the optical pulse signal generated by the EAM.

117. A method as claimed in claim 116 comprising the further step of:
c) modulating the phase of the optical signal to generate variable duty cycle RZ optical pulse with variable chirp compensation.

118. A method as claimed in claim 116 wherein the variable chirp compensation is provided using a phase modulator supplied with DC and AC voltages.

119. A method comprising the step of:
a) generating an optical non-return-to-zero (NRZ) data signal with variable chirp compensation.

120. A method comprising the step of:
a) generating a RZ optical data signal with variable duty cycle and/or variable chirp.

121. A method of integrating a multi-quantum-well (MQW) based electro-absorption device with a non-absorption device comprising the step of:
a) area-selectively disordering the MQWs of the non-absorption device section.

122. A method as claimed in 121 wherein the non-absorption device is a phase modulator.

123. A method as claimed in 121 wherein the non-absorption device is a intensity modulator.

124. A method as claimed in 121 wherein the intensity modulator is an NRZ modulator.

125. A method as claimed in 121 wherein the non-absorption device is a splitter.
